(19) United States
(12) Patent Application Publication
(10) Pub. No.: US 2015/0058124 A1
(43) Pub. Date: Feb. 26, 2015

(54) SYSTEM AND METHOD FOR GENERATING, UTILIZING AND MANAGING GEOGRAPHICAL SPECIFIC DEALS

(71) Applicant: RANVIR SINGH SETHI, BRISBANE (AU)

(72) Inventor: RANVIR SINGH SETHI, BRISBANE (AU)

(21) Appl. No.: 14/467,011

(22) Filed: Aug. 24, 2014

(30) Foreign Application Priority Data
Aug. 23, 2013 (AU) 2013903221

(51) Int. Cl. G06Q 30/02

(52) U.S. Cl. CPC G06Q 30/0261; G06Q 30/0264
USPC 705/14.58

(57) ABSTRACT

A computer implemented system for generating and managing geographical specific deals comprising a deal information module that obtains information on deals from a plurality of merchants, an inventory and deal splitting module that splits each inventory comprising a plurality of products to be sold into a plurality of deals; and each deal comprising the plurality of products to be sold into a plurality of sub deals that are made available at different sub intervals of the pre defined time interval, a sub deal selection and notification module that selects a sub deal from a deal based on the location information of the shopper, and notifies the sub deal to the shopper; and a transaction identifier generation module that generates the transaction identifier for the sub deal based on a selection of the sub deal, and notifies the transaction identifier to the shopper with a validity period for the transaction identifier.

### BACKGROUND

1. Technical Field

The embodiments herein generally relates to geographical specific deals, and more particularly, to a system and method for generating, utilizing and managing geographical specific deals.

2. Description of the Related Art

In recent years it has become known for merchants to sell their products both through their bricks and mortar shop fronts and also through their websites and other online presences such as smart phone apps. Often merchants offer products through smart phone applications at a lesser price than being offered on the shop floor to walk in customers. One reason for this occurring is that merchants are keen to entice new shoppers to their shops since once the shopper is in the shop it may be possible to cross sell additional products and secure a new stream of future sales.

However, the net result of the present smart phone marketing strategy is that customers offered a special deal via their smart phone may arrive at the shop to find that the goods have already been sold to walk in customers. A deal is generally made available round the clock including the times when the store is actually closed hence a customer is lured to the store by the deal only to find it is closed. The merchant typically does not reserve the goods for the smart phone customers but rather sells to the walk in customers as they arrive. Merchant is generally very busy and continuously distracted serving customers and does not have time to manage deals, and reserve & track inventories.

This is for two reasons, firstly the merchant is keen to sell as soon as possible and secondly the walk in customer has not been offered a special deal and so is prepared to pay a higher price, which is obviously desirable for the merchant. It is very important to offer geographically targeted deal offering systems to users in a manner that does not affect normal business operations of the merchant. The merchant on the shop floor, for example a restaurant or a grocery shop, is generally very busy during trading hours and may not have time and inclination to concurrently set up various deal offerings, manipulate such deal offerings by changing their price, quantity, stopping deals, or reserving goods exclusively for customers as they may not even show up.

### SUMMARY

In view of the foregoing, an embodiment herein provides a computer implemented system for generating and managing geographical specific deals. The system comprising: (i) a memory unit that stores a database, and a set of modules;(ii) a processor that executes the set of modules comprising; (a) a deal information module, executed by the processor, that obtains information on deals from a plurality of merchants, wherein each deal comprises at least one product to be sold within a pre defined time interval; (b) an inventory and deal splitting module, executed by the processor, that splits (i) each inventory comprising the plurality of products to be sold into a plurality of deals; and (ii) each deal comprising the plurality of products to be sold into a plurality of sub deals that are made available at different sub intervals of the pre defined time interval; (c) a location module, executed by the processor, that obtains a location information of a mobile device associated with a shopper; (d) a sub deal selection and notification module, executed by the processor, that (i) selects at least one sub deal from a deal based on the location information of the shopper, wherein the deal and the sub deal are obtained from the database, and (ii) notifies the at least one sub deal to the shopper; (e) a transaction identifier generation module, executed by the processor, that (i) receives a request for a transaction identifier based on a selection of the at least one sub deal by the shopper from the mobile device associated with the shopper for transaction, (ii) generates the transaction identifier for the at least one sub deal based on the request, and (iii) notifies the transaction identifier to the shopper with a validity period for the transaction identifier and (f) an inventory and deal updating module that updates an inventory, a price, and a number of remaining sub deal based on a utilization of previous sub deals.

The transaction identifier comprises three to five symbols such as numbers, letters or a mixture of both. The location obtaining module obtains location of a store, and a location of other shoppers interested in the deal. The transaction identifier generation module reuses the transaction identifier for a new transaction after expiry of the deal associated with the transaction identifier. A transaction identifier verification module that; (a) compares (i) a transaction identifier received from a merchant with (ii) the transaction identifier of the shopper for the sub deal; and (b) verifies whether the sub deal are being sold at a coupon price when a match is found between (i) the transaction identifier received from the merchant and (ii) the transaction identifier of the shopper.

In another embodiment, a computer implemented method for generating and managing geographical specific deals is provided. The computer implemented method comprising: (i) obtaining information on a plurality of deals from a plurality of merchants, wherein each deal comprises at least one product to be sold within a pre defined time interval,(ii) obtaining (a) a plurality of sub deals of the deal that are made available at different sub intervals of the pre defined time interval, (iii) obtaining a location information of a mobile device associated with a shopper; (iv) selecting at least one deal from the plurality of deals based on the location information of the shopper; (v) notifying the at least one sub deal, from the at least one deal to the shopper, wherein the sub deal comprises a validity period after which the sub deal expires; (vi) receiving a request for a transaction identifier based on a selection of the at least one sub deal by the shopper from the mobile device associated with the shopper for transaction; (vii) generating the transaction identifier for the at least one sub deal based on the request; (viii) notifying the transaction identifier and the validity period for the sub deal to the shopper; (ix) receiving a transaction identifier from a merchant for the sub deal;(x) compares the transaction identifier received from the merchant with the transaction identifier of the shopper for the sub deal.

A geographical distance between a merchant's location and a current location of the shopper is determined. The shopper of the sub deal, wherein the sub deal comprises a price or discount, number of products remaining and time remaining to reach a merchant's location is notified. The sub deals have an expiry time calculated such that shoppers that are already in the area of the merchant's location corresponding to the deal have adequate time to reach the merchant's location before the expiry time. A plurality of requests from a plurality of shopper devices received within at least one sub interval of the pre define time interval, determining a number of interested shoppers in the at least one sub deal based on the plurality of requests for the at least one sub interval, and determining a plurality of products to be sold for the at least one sub deal within the at least one sub interval of the pre defined time interval is provided. The sub deal are being sold at a coupon price when a match is found between (i) the transaction identifier received from the merchant and (ii) the transaction identifier of the shopper is verified.

In yet another embodiment, a computer implemented device for availing for geographical specific deals comprising: (i) a memory unit that stores a database, and a set of modules; (ii) a processor that executes the set of modules comprising; (a) a selection module, executed by the processor, that (i) selects a first deal from a plurality of deals that is obtained from a server; and (ii) receives a transaction identifier associated with the first deal; (b) a deal display module, executed by the processor, that (i) displays, at an interface of the device, a price or discount information associated with the first deal, number of products in the first deal remaining to be sold, and duration remaining to avail the first deal; and (ii) displays, at the interface, a second deal when a shopper rejects the first deal the shopper, and (c) a categorizing module, executed by the processor, that categorizes the sub deal based on a color coding, wherein a particular color indicates that ample time is available, wherein another color indicates that there is barely enough time for a shopper to reach a shop that is associated with the sub deal.

A feedback module that facilitates the submission of the shopper feedback. An alert module that generates and displays an alert on the device prior to an expiry time of the deal.

In yet another further embodiment, a computer implemented device for utilizing geographical specific deals, the computer implemented method comprising device comprising: (i) a memory unit that stores a database, and a set of modules;(ii) a processor that executes the set of modules comprising; (a) an inventory allocation module, executed by the processor, that allocates an inventory to shoppers from a plurality of inventories;(b) a deal submission module, executed by the processor, that submits information specific to a deal to a server, wherein the information specific to the deal comprises an associated geographical location of a merchant's shop and one or more associated time parameters indicating periods in which the deal is available; (c) a fulfillment verification module, executed by the processor, that (i) verifies an offer set out in the deal when a match is found between transaction identifier entered on the device with a transaction identifier that is stored in a server;(ii) performs a check from the inventory, for (i) an availability of the deal and (ii) the offer set out in the deal; and (iv) executes an action based on the check, and (d) an operation module, executed by the processor, that terminates an operation on the deal when the deal is unavailable. The action comprises completing a transaction associated with the deal. The action comprises declining a transaction associated with the deal.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of a merchant providing deals to shoppers according to an embodiment herein;

FIG. 2 illustrates an exploded view of a server according to an embodiment herein;

FIG. 3 illustrates a user interface view of a geospatial device running an application according to an embodiment herein;

FIG. 4 illustrates a user interface view of a geospatial device running an application according to an embodiment herein

FIG. 5A illustrates an exploded view of a geospatial device according to an embodiment herein;

FIG. 5B illustrates an exploded view of a merchant device according to an embodiment herein.

FIG. 6 illustrates a user interface view of a geospatial device running an application according to an embodiment herein;

FIG. 7 illustrates a user interface view of a geospatial device running an application according to an embodiment herein;

FIG. 8 illustrates a user interface view of a geospatial device running an application according to an embodiment herein;

FIG. 9 is a flowchart of a method for operating a geospatial device according to an embodiment herein;

FIG. 10 is a flowchart of a method for creating a transaction identifier according to an embodiment herein;

FIG. 11 illustrates a user interface view of a geospatial device running an application according to an embodiment herein;

FIG. 12 illustrates a user interface view of a geospatial device running an application according to an embodiment herein;

FIG. 13 illustrates a user interface view of a geospatial device running an application according to an embodiment herein;

FIG. 14 is a flowchart of a method for deal redemption according to an embodiment herein;

FIG. 15 illustrates a user interface view of a geospatial device running an application according to an embodiment herein;

FIG. 16 illustrates a user interface view of a geospatial device running an application according to an embodiment herein;

FIG. 17 illustrates a user interface view of a geospatial device running an application according to an embodiment herein;

FIG. 18 illustrates a user interface view of a geospatial device running an application according to an embodiment herein;

FIG. 19 illustrates a user interface view of a geospatial device running an application according to an embodiment herein;

FIG. 20 illustrates a user interface view of a geospatial device running an application according to an embodiment herein;

FIG. 21 illustrates a user interface view of a geospatial device running an application according to an embodiment herein;

FIG. 22 illustrates a user interface view of a geospatial device running an application according to an embodiment herein;

FIG. 23 illustrates a user interface view of a geospatial device running an application according to an embodiment herein;

FIG. 24 illustrates a user interface view of a geospatial device running an application according to an embodiment herein;

FIG. 25 illustrates a user interface view of a geospatial device running an application according to an embodiment herein;

FIG. 26 is a flowchart of a method for deriving sub deals from a deal according to an embodiment herein;

FIG. 27 is illustrates the division of a deal into a plurality of sub deals according to an embodiment herein;

FIG. 28 is a flowchart of a method for processing merchant store closure according to an embodiment herein;

FIG. 29 is a flowchart of a method for processing ad hoc merchant store closure according to an embodiment herein;

FIG. 30 illustrates a user interface view of a geospatial device running an application according to an embodiment herein;

FIG. 31 illustrates a user interface view of a geospatial device running an application according to an embodiment herein;

FIG. 32 is a flowchart of a method for splitting a deal into a sub deal according to an embodiment herein; and

FIG. 33 is a flowchart of a method for updating price and inventory of a sub deals according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description.

Descriptions of well-known components and processing techniques are omitted so as to not unnecessarily obscure the embodiments herein. The examples used herein are intended merely to facilitate an understanding of ways in which the embodiments herein may be practiced and to further enable those of skilled in the art to practice the embodiments herein. Accordingly, the examples should not be construed as limiting the scope of the embodiments herein.

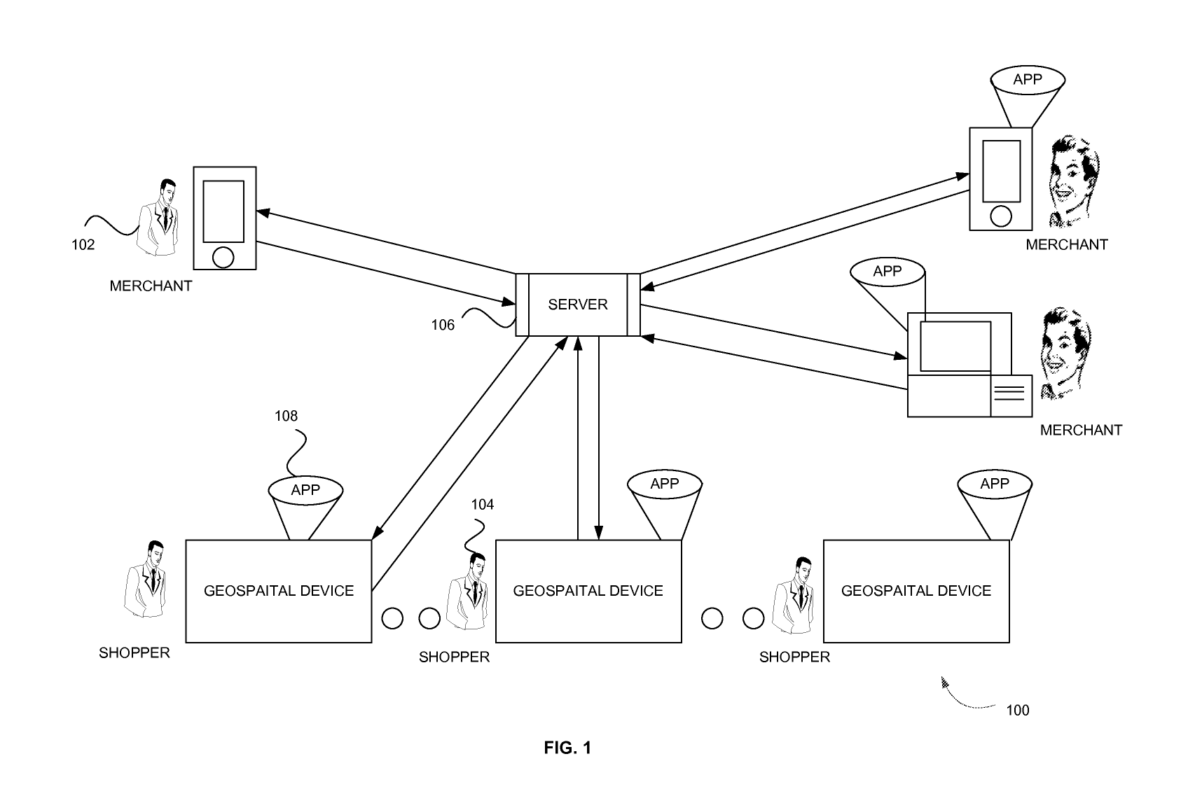

There remains a need for a system and method for splitting a deal into number of sub deals that are available at different time intervals. Referring now to the drawings, and more particularly to FIGS. 1 through 33, where similar reference characters denote corresponding features consistently throughout the figures, there are shown in preferred embodiments.

FIG. 1 illustrates a system view 100 of a merchant 102 providing deals to shoppers 104 according to an embodiment herein. The system includes a server 106 that is suitably programmed to implement and interact with a database. From a hardware perspective the server may be a single physical server or it may be distributed over a number of hardware platforms. In one embodiment, the server 106 also interacts with a plurality of geospatial devices, e.g. mobile devices, which each running an application 108 according to an embodiment herein.

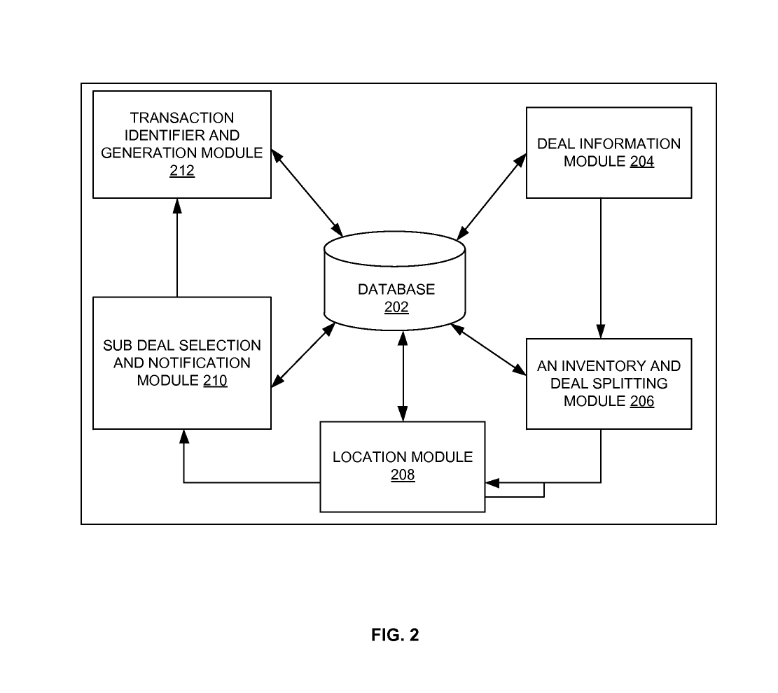

FIG. 2 illustrates an exploded view of the server 106 of FIG. 1 according to an embodiment herein. The database includes a deal information module 204, an inventory and deal splitting module 206, a location module 208, a sub deal selection and notification module 210 and a transaction identifier and generation module 212. In one embodiment, the deal information module 204 obtains information on deals from one or more merchants 102 of FIG. 1 where each deal may include at least one product to be sold within a pre defined time interval. The inventory and deal splitting module 206 splits each inventory including one or more products to be sold into one or more deals. The inventory and deal splitting module 206 splits each deal comprising one or more products to be sold into one or more sub deals that may be available at different sub intervals of the pre defined time interval. The location module 208 obtains location information of a mobile device associated with a shopper 104 of FIG. 1. The sub deal selection and notification module 210 selects at least one sub deal from a deal based on the location information of the shopper 104 of FIG. 1 where the deal and the sub deal are obtained from the database 202. The sub deal selection and notification module 210 notifies at least one sub deal to the shopper 104 of FIG. 1. The transaction identifier and generation module 212 receives a request for a transaction identifier based on a selection of at least one sub deal by the shopper 104 of FIG. 1 from the mobile device associated with the shopper 104 of FIG. 1 for transaction. The transaction identifier and generation module 212 generates the transaction identifier for at least one sub deal based on the request and notifies the transaction identifier to the shopper 104 of FIG. 1 with a validity period for the transaction identifier.

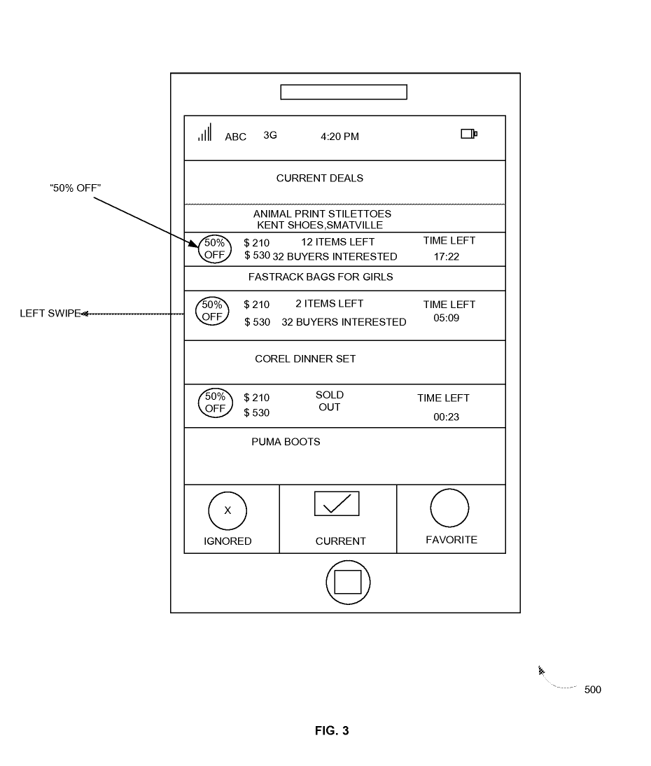

FIG. 3 illustrates a user interface view of a geospatial device running an application 108 of FIG. 1 according to an embodiment herein. In one embodiment, the shopper 104 of FIG. 1 may not be interested in a deal that is presented and may wish to ignore it by swiping on the left hand side on the deal window. Obviously, left swiping is only one example of a method of indicating to the application 108 of FIG. 1 that the shopper 104 of FIG. 1 wishes to ignore the deal. In one embodiment, if the shopper 104 of FIG. 1 indicates to ignore the deal by left swiping then the application 108 of FIG. 1 retrieves another deal that may be of interest from the server 106 of FIG. 1. The shopper 104 of FIG. 1 is presented with new deals when it (i.e. he or she) actively ignores a deal by left swiping on it or alternatively when sufficient time has passed so that the deal has expired or alternatively when the mobile device has moved out of the relevant geographical area for the particular deal.

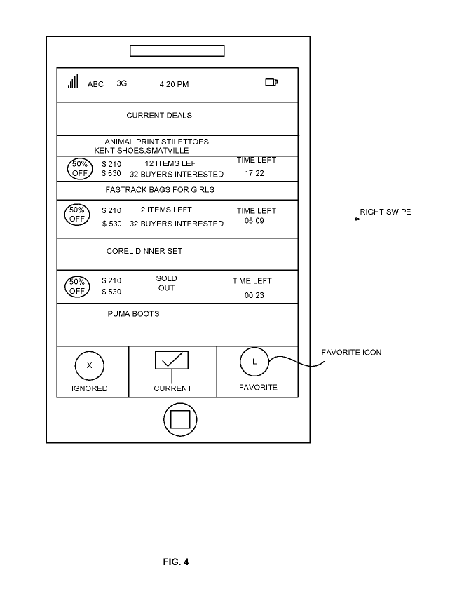

FIG. 4 illustrates a user interface view of a geospatial device running an application 108 of FIG. 1 according to an embodiment herein. In one embodiment, in the event that the shopper 104 of FIG. 1 is interested in one of the deals presented on the mobile device then it may indicate its interest by right swiping as shown to mark the deal e.g. “Fastrack Bags for Girls” as a favorite, then the heart shaped favorite icon at the bottom right of the screen in FIG. 4 will flash.

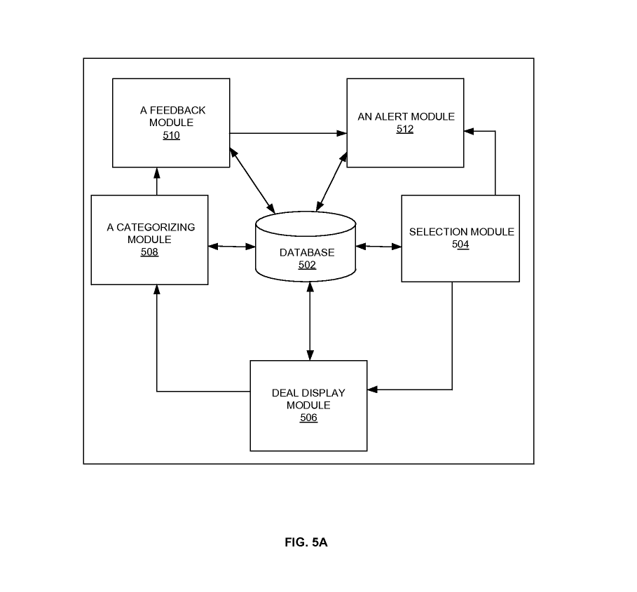

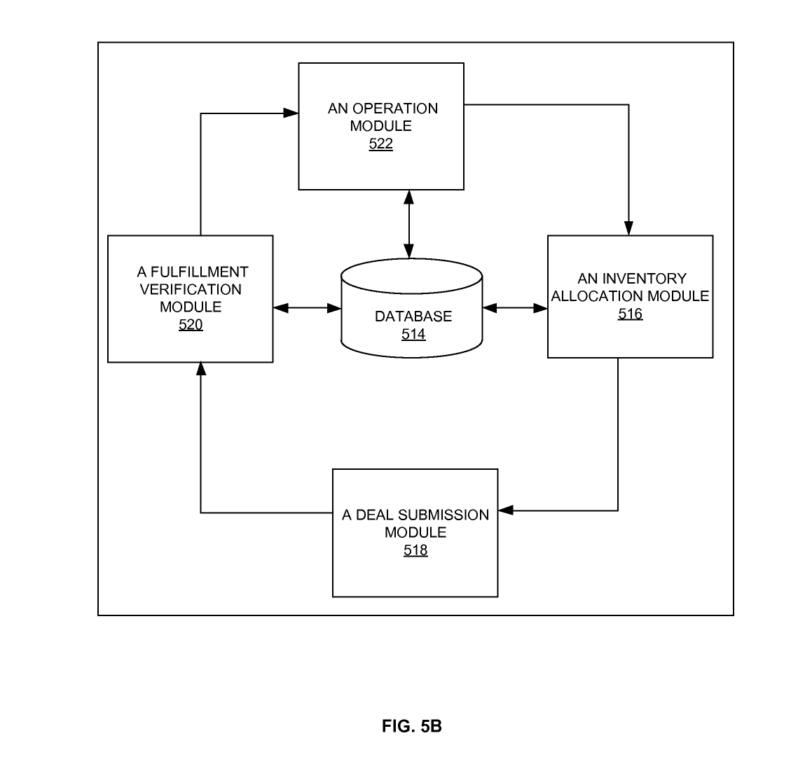

FIG. 5A illustrates an exploded view of a geospatial device according to an embodiment herein. The database 502 includes a selection module 504, a deal display module 506, a categorizing module 508, a feedback module 510, and an alert module 512. In one embodiment, the selection module 504 selects a first deal from a plurality of deals that is obtained from a server 106 of FIG. 1. The deal display module 506 displays, at an interface of a device, a price or discount information associated with the first deal, number of products in the first deal remaining to be sold, and duration remaining to avail the first deal. The deal display module 506 displays, at the interface, a second deal when a shopper 104 of FIG. 1 rejects the first deal from the shopper 104 of FIG. 1. The categorizing module 508 categorizes the sub deal based on a color coding, where a particular color indicates that ample time is available, where another color indicates that there is barely enough time for a shopper 104 of FIG. 1 to reach a shop that is associated with the sub deal. The feedback module 510 facilitates the submission of the shopper 104 of FIG. 1 feedback. The alert module 512 generates and displays an alert on the device prior to an expiry time of the said deal.

FIG. 5B illustrates an exploded view of a merchant device according to an embodiment herein. The database 514 includes an inventory allocation module 516, a deal submission module 518, a fulfillment verification module 520, and an operation module 522. In one embodiment, the inventory allocation module 516 allocates an inventory to shoppers from a plurality of inventories. The deal submission module 518 submits information specific to a deal to a server 106 of FIG. 1, where the information specific to the deal comprises an associated geographical location of a merchant's shop and one or more associated time parameters indicating periods in which the deal is to be available. The fulfillment verification module 520 verifies an offer set out in the deal when a match is found between transaction identifier entered on the device with a transaction identifier that is stored in a server 106 of FIG. 1. The fulfillment verification module 520 performs a check from the inventory, for (i) an availability of the deal and (ii) the offer set out in the deal. The operation module 522 terminates an operation on the deal when said deal is unavailable.

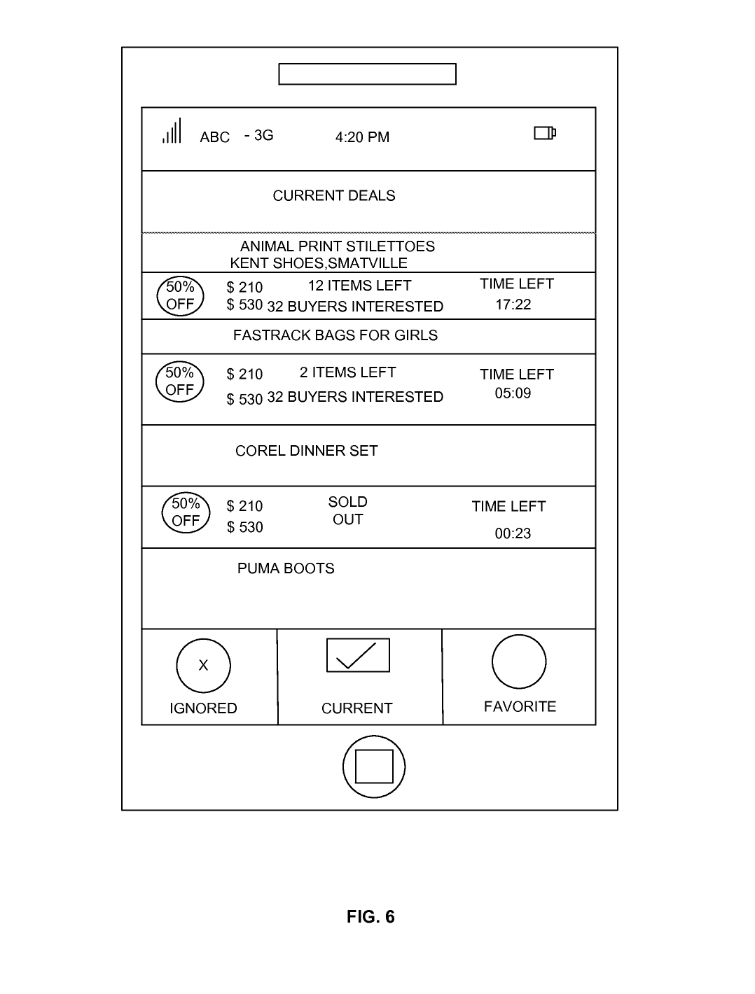

FIG. 6 illustrates a user interface view of a geospatial device running an application 108 of FIG. 1 according to an embodiment herein. The application 108 of FIG. 1 deals, e.g. “Fastrack Bags for Girls”, “Puma Boots” and “Animal Print Stilletoes” are color coded for example red, yellow or green depending on the mobile device's distance from the store and/or time left until the deal expires. For example if the shopper 104 of FIG. 1 sees a deal that is coded red then it will be realized that action must be taken immediately to reach the store in time to take advantage of the deal before it expires. However, such an action may be ineffective depending on the travel time required to reach the store, there is a high probability that the deal would be expired by then. In one embodiment, if the deal is color coded green then that indicates that there is ample time whereas a yellow color coding indicates an intermediate situation.

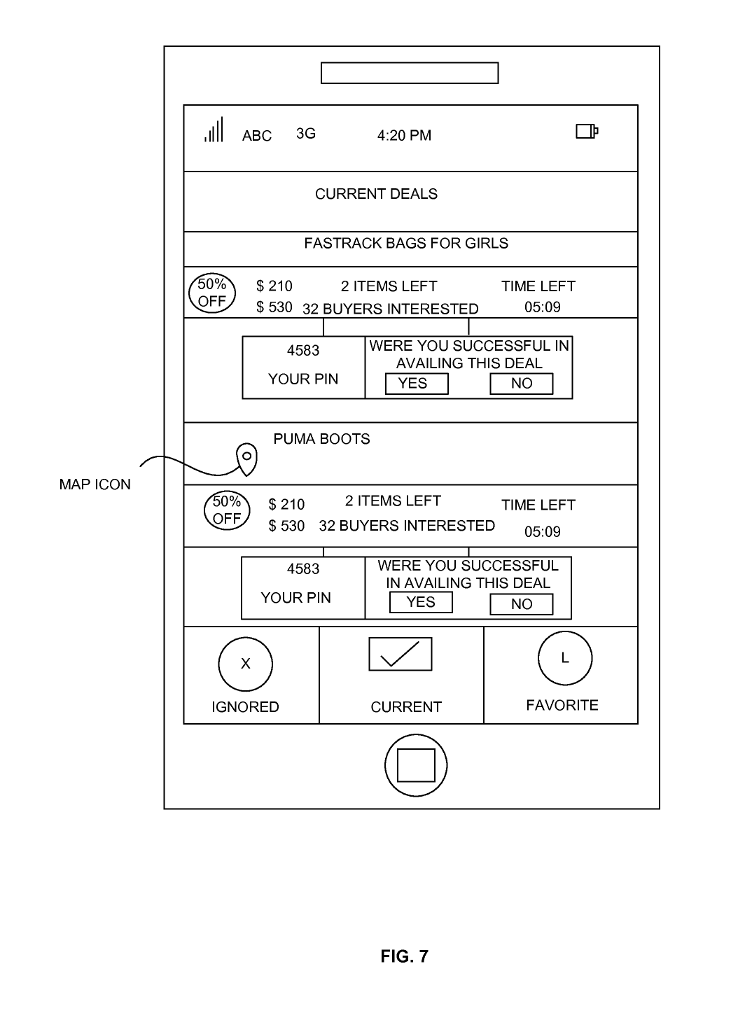

FIG. 7 illustrates a user interface view of a geospatial device running an application 108 of FIG. 1 according to an embodiment herein. In one embodiment, once the shopper 104 of FIG. 1 taps on the heart shaped favorite icon, the shopper 104 of FIG. 1 sees its favorite deals as shown in FIG. 7, which shows the dollar amount for the deal (i.e. $210), discount off normal pricing (i.e. 50% off) the number of items that are left for sale (i.e. “2 items left”) the time left before the deal expires (i.e. 5 minutes and 9 seconds). The screen of FIG. 7 also shows a transaction identifier (i.e.“4853”) or as it might equivalently be called a PIN number or a “coupon”. When a deal is found interesting and marked as such by the shopper 104 of FIG. 1, it effectively turns into a coupon for that shopper 104 of FIG. 1 and a pending transaction record is created for the shopper 104 of FIG. 1 in the database 202 of FIG. 2. This transaction record will also expire with a grace period of say 15 minutes. The act of creating a pending transaction record also creates a small digit small transaction identifier. These numbers are destroyed and reused with the expiry of the coupon or if the deal gets redeemed.

In one embodiment, as each transaction identifier numbers' life is brief, the numbers can be reused. The Small Transaction Identifiers are sufficiently short such that they can be voice transmitted over the phone to book an appointment or buy goods, or spoken across the sales counter. Therefore they are much more efficiently transmitted than optical IDs such as bar codes and QR codes. It will be realized that the small transaction identifiers identify a pending transaction that is about to expire within minutes, rather than a person. It will also be realized that small transaction identifier is a number only as an example, it can equally well be a small set of alphabetical letters or mix of letters, and numbers or other symbols.

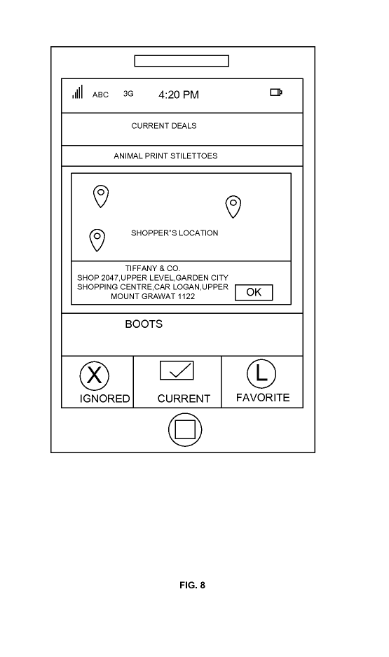

FIG. 8 illustrates a user interface view of a geospatial device running an application 108 of FIG. 1 according to an embodiment herein. In one embodiment, if the shopper 104 of FIG. 1 clicks on the map icon presented which features a map showing both the shopper's location (i.e. the location of the shopper's mobile device and a map of the location of the store in which the deal may be redeemed. That is, the shopper 104 of FIG. 1 can see on a map on his mobile device his location, the location of the store, the location of other shoppers interested in the same deal, and driving instructions for reaching the store from his current location. The shopper 104 of FIG. 1 also sees his numeric position in relation of others who are interested in the same deal based on his current distance from that store.

In one embodiment, only nearest deals are shown first from a range of diverse stores. Farther stores are shown when nearby stores' deals are explicitly marked ‘ignored’ (e.g. left swiped). Therefore, as more and more deals are ignored, farther deals are made visible. But since they are far, they come with warnings that the deals are far enough that they may end before the shopper 104 of FIG. 1 reaches there to redeem. This way, farther deals turn into an advertisement of a faraway store simply because local businesses are not putting up any deals or deals that are interesting to shoppers in their area. Deals that are about to expire when the shopper 104 of FIG. 1 is nearby, have a built in alarm to remind the shopper 104 of FIG. 1. Expired deals are removed from the application 108 of FIG. 1. However, if the deal is marked favorite, such deals are deleted after a grace period over its natural expiry, of say 15 minutes.

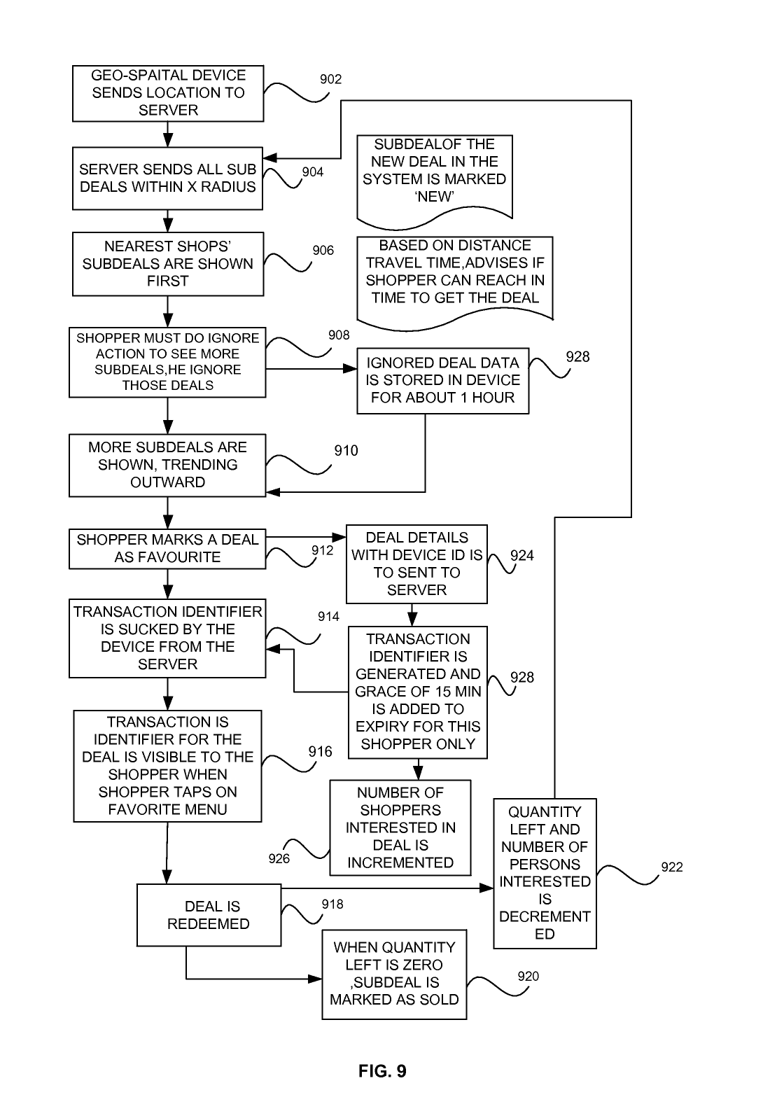

FIG. 9 is a flowchart of a method for operating a geospatial device according to an embodiment herein. In one embodiment, the same application 108 of FIG. 1 also operates on the merchant's computational device which may also be a mobile device, tablet, notebook, laptop or desktop computer for example. In step 902 the application 108 of FIG. 1 sends the geo-spatial device, i.e. the shopper's mobile device, location to the server 106 of FIG. 1. In step 904, the server 106 of FIG. 1 finds all sub deals in its database 202 of FIG. 2 within a predetermined geographical area, e.g. within a 80-100 km radius of the shopper's mobile device to the device. In step 906, the application 108 of FIG. 1 receives the details of the shops offering the deals that the server 106 of FIG. 1 has found and displays nearest sub deals first to the shopper 104 of FIG. 1. In step 908, the application 108 of FIG. 1 waits for the shopper 104 of FIG. 1 to do an ignore action (e.g. a left swipe) on the displayed deal. In step 910, more sub deals are shown trending geographically further outward from the mobile device's location. In one embodiment, in step 912 the shopper 104 of FIG. 1 marks a deal as a “favourite” (e.g. by right swiping as shown in FIG. 4.).

In step 914, the application 108 of FIG. 1 transmits the details of the favored deal with the mobile devices ID to the server 106 of FIG. 1. The server 106 of FIG. 1 then increments the number of shoppers interested in the deal in its records. In step 916 the application 108 of FIG. 1 makes the transaction identifier for the deal visible to the shopper 104 of FIG. 1 upon the shopper 104 of FIG. 1 selecting the favorite menu (as shown in the screen of FIG. 7) and in step 918 the deal is redeemed. In step 920, when the quantity left is zero, sub deal is marked as sold. In step 922, quantity left and number of persons interested is decremented. In step 924, the deal details are sent to the server 106 of FIG. 1. In step 926, number of shoppers interested in the deal is incremented. In step 928, transaction identifier is generated and grace of 15 min is added to expiry for the shopper 104 of FIG. 1 only. The redemption process involves the shopper 104 of FIG. 1 physically entering the merchants store and purchasing the product at the agreed price.

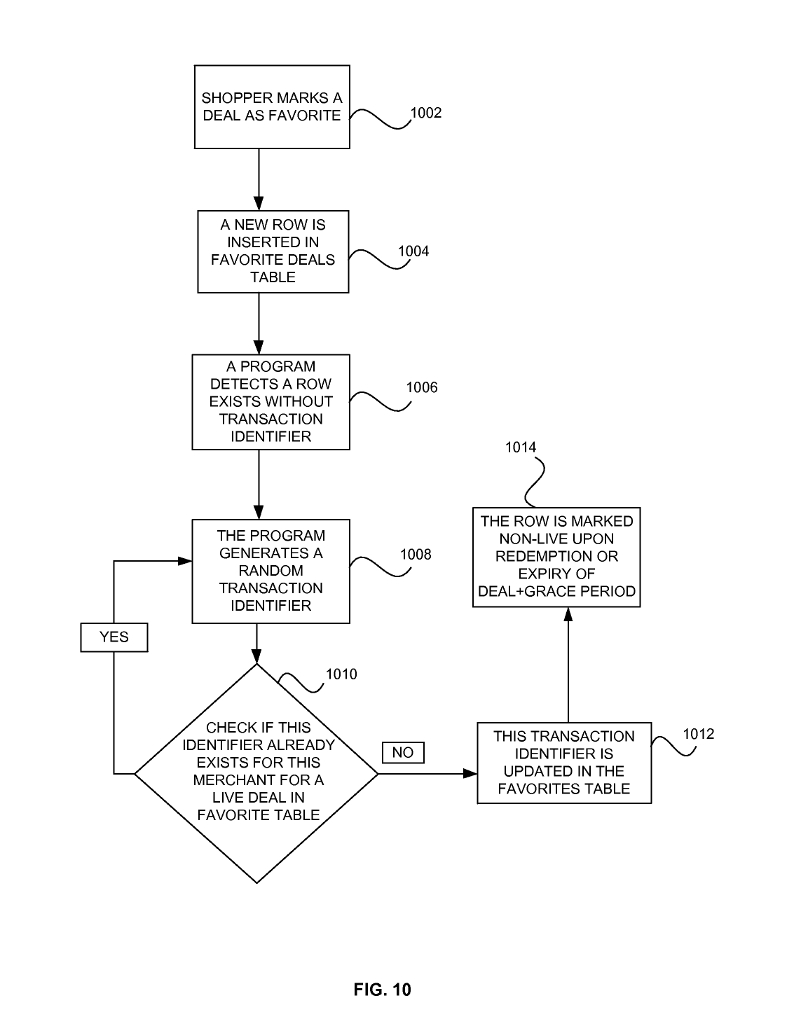

FIG. 10 is a flowchart of a method for creating a transaction identifier according to an embodiment herein. In step 1002 the shopper 104 of FIG. 1 marks a deal as favorite on his mobile device, e.g. by right swiping as shown in FIG. 4. The application 108 of FIG. 1 running on the mobile device then transmits that information to the server 106 of FIG. 1 which, in step 1004, in response inserts a new row in the Transaction ID/favorites table. In step 1006, the database program detects that a new row exists without a transaction identifier value. In step 1008 the program generates a random transaction identifier. In step 1010 the program checks to see if the randomly generated transaction identifier already exists for live deals of the merchant 102 of FIG. 1 in the favorites table. If the check fails then the process reverts to step 1008 and another random transaction identifier is generated. Otherwise the process continues to step 1012 and the transaction identifier is inserted into the favorites table. In step 1014 the row is marked as being non-live upon redemption or expiry of the timeframe defined by the deal duration and grace period time frames.

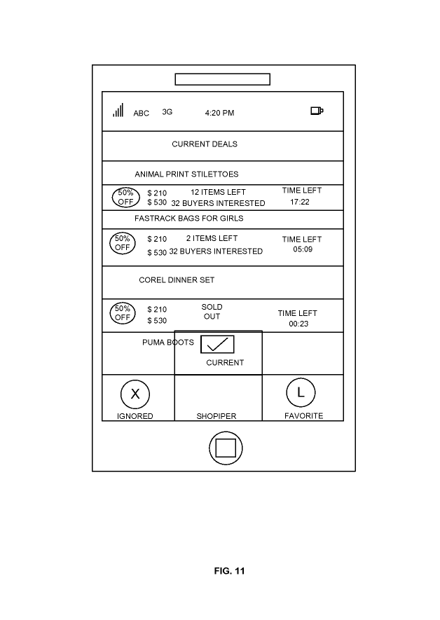

FIG. 11 illustrates a user interface view of a geospatial device running an application 108 of FIG. 1 according to an embodiment herein. In one embodiment, a setup or utility button may be used by either a shopper 104 of FIG. 1 or a merchant 102 of FIG. 1 for operating the mobile device.

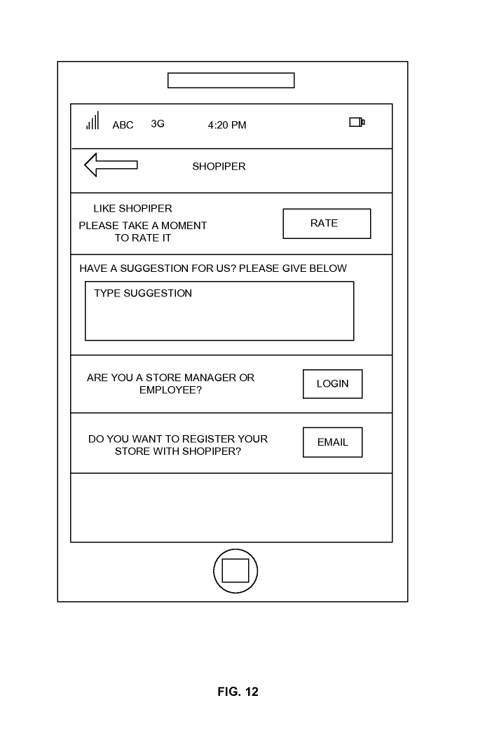

FIG. 12 illustrates a user interface view of a geospatial device running an application 108 of FIG. 1 according to an embodiment herein. FIG. 12 shows a shopper 104 of FIG. 1 feedback screen which facilitates the entry of shopper 104 of FIG. 1 feedback about the application 108 of FIG. 1.

The FIG. 12 also asks shoppers if they wish to sign up as merchants to the service in the event that they operate their own store. Once a merchant 102 of FIG. 1 has created an account he is able to upload his deal through the application 108 of FIG. 1. The merchant 102 of FIG. 1 can also upload a deal across several stores through the application 108 of FIG. 1. Each store's trading hours, daylight savings and time zone are stored and used in ensuring that the deal is only visible if the store is actually open. Standard industry and town specific calendars may be created, and stores may select one that applies to them, and thereafter, store may just need to supply any exceptions to the calendar from time to time to the server.

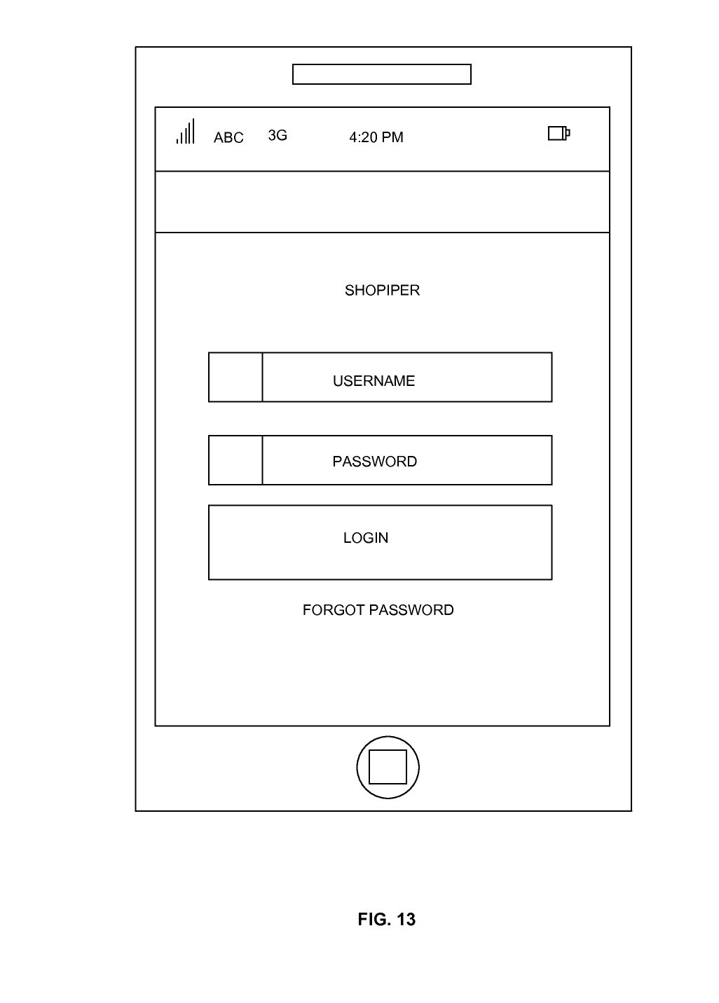

FIG. 13 illustrates a user interface view of a geospatial device running an application 108 of FIG. 1 according to an embodiment herein. FIG. 13 displays a login screen for merchant 102 of FIG. 1 or a shopper 104 of FIG. 1 to log into the system and access their account.

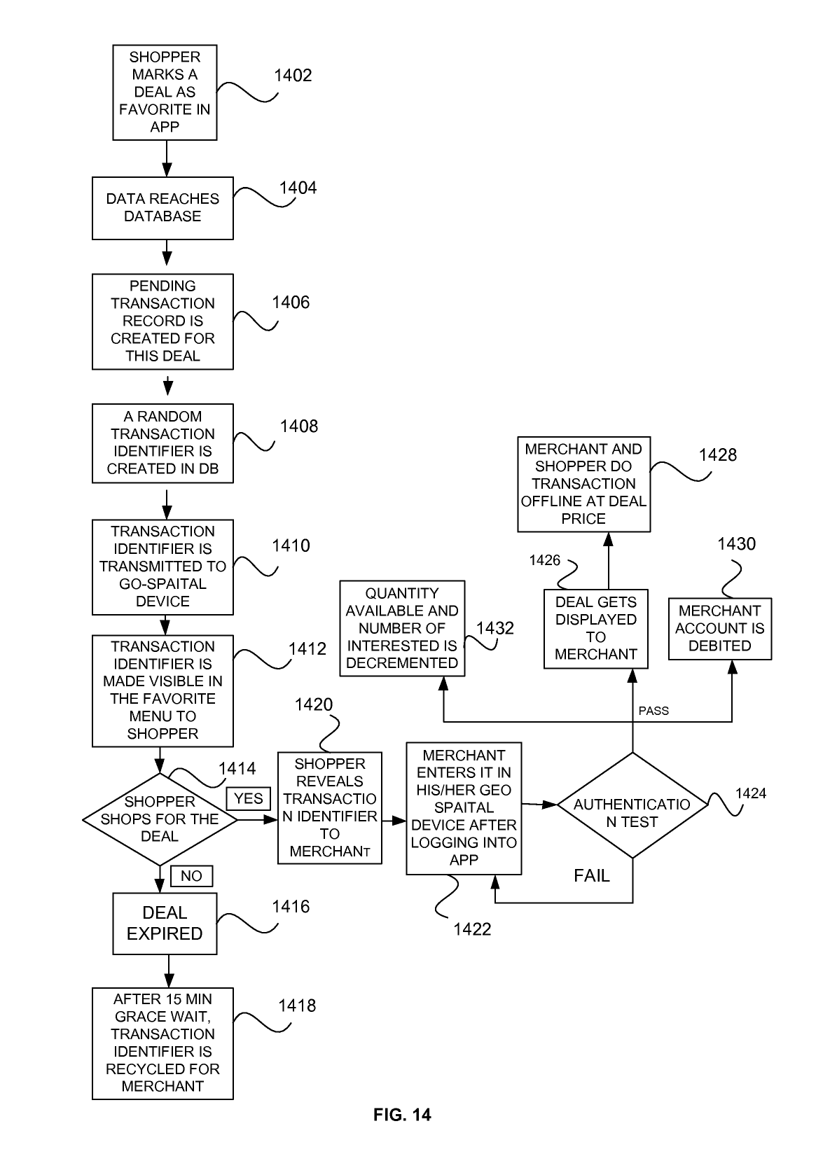

FIG. 14 is a flowchart of a method for deal redemption according to an embodiment herein. In step 1402, the shopper 104 of FIG. 1 marks a deal as being a “favorite” for example by right swiping the deal on the mobile device application screen as shown in FIG. 4. In step 1404, the data associated with the shopper's selection of the deal as a favorite reaches the database by means of the cell phone telecommunications network and internet gateways. The data associated with the shopper's selection of the deal as a favorite will include, for example merchant_id, sub deal_id, mobile device_id as these uniquely identify merchant 102 of FIG. 1, its sub deal and the shopper 104 of FIG. 1 who has marked it as favorite. In step 1406, the system creates a pending transaction record for the deal. In step 1408, a random transaction identifier is created in the database and associated with the deal.

In step 1410, the server 106 of FIG. 1 transmits the transaction identifier to the geospatial device, i.e. to the shopper's mobile device. In step 1412, the application 108 of FIG. 1 on the shopper's mobile device makes the transaction identifier visible to the shopper 104 of FIG. 1, for example by displaying the screen that is shown in FIG. 7. In step 1414 the shopper 104 of FIG. 1 either shops or does not shop for the deal. That is, the shopper 104 of FIG. 1 either attends at the store to present the transaction identifier to the merchant 102 of

FIG. 1 and avail him/herself or the deal or does not visit the store. If the shopper 104 of FIG. 1 does not attend at the store then at step 1416, after the deal transaction deadline has passed which includes a grace period after deal expiry, the favorite deal will be deemed to have expired for the interested shopper 104 of FIG. 1. Consequently, the deal is no longer visible on the shopper's mobile device. In step 1418, the transaction identifier is then recycled for the merchant 102 of FIG. 1 in question. This means that the transaction identifier may be used again for other deals offered by the merchant 102 of FIG. 1 in the future. Consequently, since reusing of the transaction identifiers is possible they can be kept relatively short, e.g. four digits in length so that they are readily memorized and recited by humans. In step 1414 the shopper 104 of FIG. 1 does attend at the store then at step 1420 the shopper 104 of FIG. 1 reveals the transaction identifier that was issued in step 1412 to the merchant.

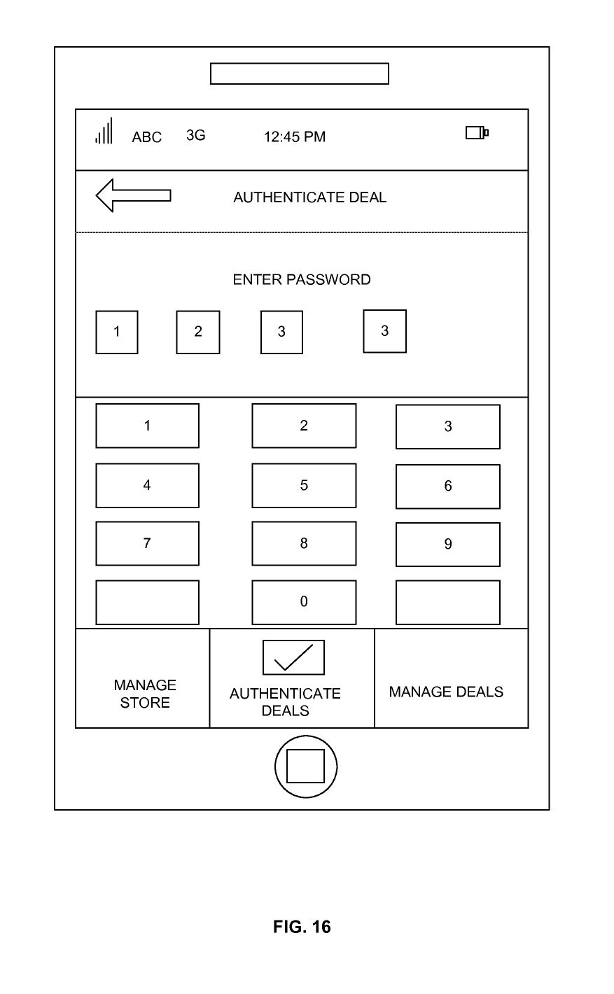

In step 1422 the merchant enters the transaction identifier that the shopper 104 of FIG. 1 has provided into the Merchant's mobile device as shown in FIG. 16. In step 1424, the authenticity of the transaction identifier is tested by the system. If the transaction identifier fails the authentication test then the process reverts to step 1422 and the merchant 102 of FIG. 1 is provided with another opportunity to enter the transaction identifier. The transaction identifiers are statistically secure locks as they are entered by the merchant 102 of FIG. 1 himself after logging into the system upon having been verbally communicated by the shopper 104 of FIG. 1. Therefore, he has no incentive to attempt to repeatedly enter them to fraudulently determine one. Moreover, the act of entering the transaction identifier correctly does not lead to a sale, but a mere verification that the sale should happen at the coupon price. As the small transaction identifier expires after a short period of time, it is available for reuse for within the same store. Compulsive repeat fails of small transaction identifier entry are recorded and reported to the owner of the business along with the attempter's login details, who will typically be an employee.

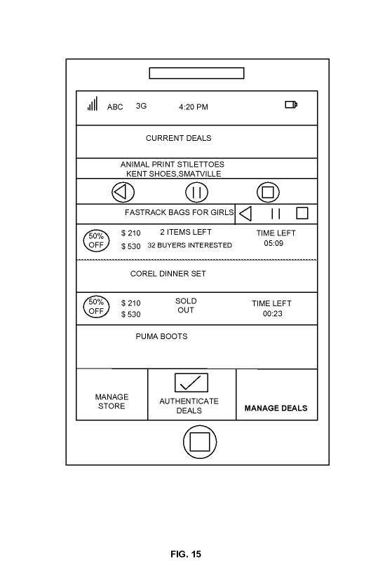

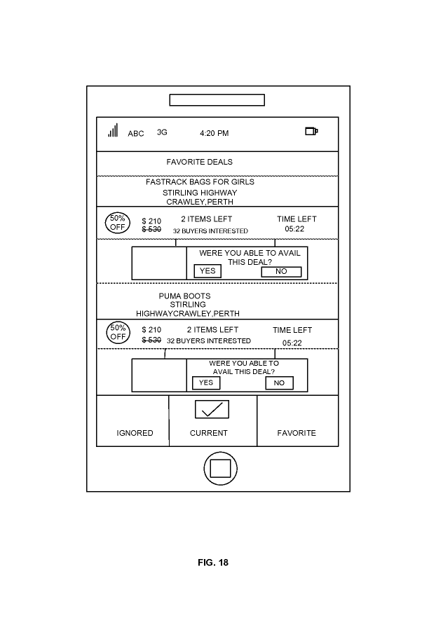

If the transaction identifier passes the authentication test in step 1424 then the process proceeds to step 1426. In step 1426, the details of the deal are displayed to the merchant 102 of FIG. 1 as shown in FIG. 15. The act of entering the small transaction identifier, and its being correct, conveys to the merchant 102 of FIG. 1 that he must now sell the product to the shopper 104 of FIG. 1 at the coupon price. The details of the deal are shown to the merchant 102 of FIG. 1 as an output as a result of acceptable transaction identifier. This output also presents the merchant with a ready opportunity to the merchant to immediately stop (or pause) the very same deal that is being redeemed for every time it is redeemed. This is crucial for the merchant on the shop floor to have ready access to manipulate this deal at every instance that it is redeemed as he is extremely busy and continuously interacting with other workers and serving customers and does not have time to search for the deal that has not only outlived its usefulness to the business, but now being counterproductive. Hence, the act of entering transaction identifier correctly precludes the need to search for the deal to stop the deal. This switch to stop the deal is not to be used in the normal course, but when its use is required, it could be an emergency as it notifies the customers that the deal is over so that they stop coming to the store for it. Upon a successful transaction identifier being entered by the merchant 102 of FIG. 1 a success authentication is sent to the shopper 104 of FIG. 1 and he is awarded application 108 of FIG. 1 loyalty credits. Simultaneously, the merchant's subscriber account in the database is debited an amount which corresponds to a payment to the system owner and is some predetermined amount or percentage of the deal. The merchant's inventory associated with the deal, i.e. the number of products available for sale is also decremented. Number of shoppers interested in the deal is also decremented. The inventory amount and number of shoppers interested may be seen by the shopper in the screen of FIG. 18 for example. In step 1428, the merchant 102 of FIG. 1 and the shopper 104 of FIG. 1 perform the transaction offline at the agreed, advertised, transaction price that was displayed when the shopper 104 of FIG. 1 indicated his willingness to take on the deal.

FIG. 15 illustrates a user interface view of a geospatial device running an application 108 of FIG. 1 according to an embodiment herein. In one embodiment, the details of the deal are displayed to the merchant 102 of FIG. 1 in FIG. 15. In one embodiment, when correct transaction identifier is entered, the deal is shown on merchant's device for his ready reference as to what were the terms of that deal. At this time with a simple action like left swipe, the merchant is able to view stop, start and pause buttons. The merchant 102 of FIG. 1 can instantly stop or pause the deal if his inventory is unsatisfactory. If the deal is stopped/paused its display to shopper's ceases except those who have marked it as favorite, an alert is sent to all shoppers who have marked this deal as favorite informing that this deal has been unexpectedly dropped by the merchant 102 of FIG. 1. Pause lets the merchant restart the deal quickly as soon as sufficient inventory is reached without need to resubmit the deal information all over again. Upon entering transaction identifier correctly, a merchant may decline the transaction, however, that will also stop the deal and all shoppers who have marked this deal as favorite will be sent an alert.

FIG. 16 illustrates a user interface view of a geospatial device running an application 108 of FIG. 1 according to an embodiment herein. The merchant 102 of FIG. 1 enters the transaction identifier which the shopper 104 of FIG. 1 has provided in FIG. 16.

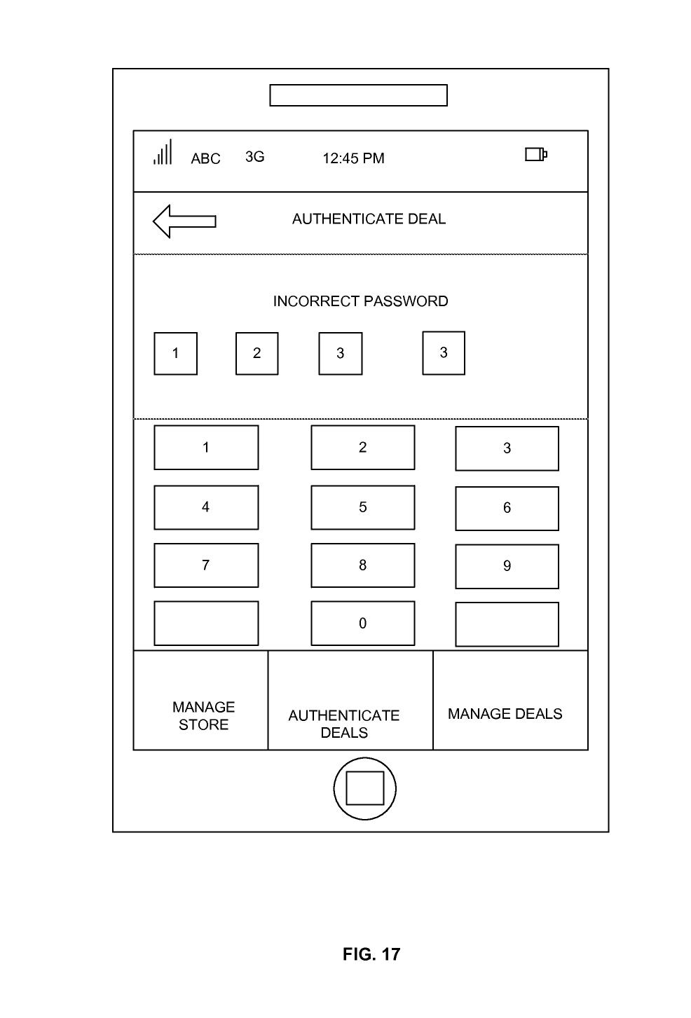

FIG. 17 illustrates a user interface view of a geospatial device running an application 108 of FIG. 1 according to an embodiment herein. The merchant 102 of FIG. 1 enters the incorrect transaction identifier which the shopper has provided in FIG. 17.

FIG. 18 illustrates a user interface view of a geospatial device running an application 108 of FIG. 1 according to an embodiment herein. The inventory amount and number of shoppers interested may be seen by the shopper 104 of FIG. 1 in FIG. 18. At the point of purchase, the shopper 104 of FIG. 1 is able to provide feedback on whether he or she was able to purchase the product at the advertised deal price or not, regardless of whether the transaction identifier is entered or not. This feedback is processed only if the shopper 104 of FIG. 1 has traversed a reasonable distance after showing interest (e.g. right swiping) in the deal. If a significant level of shopper feedback is produced indicating that the deal is not received then the merchant 102 of FIG. 1 is informed.

A repeat of the same situation occurring causes the sub deal to be stopped and deal is paused. Shopper 104 of FIG. 1 is also informed at all times if the stores has abruptly closed, quantity left, number of other shoppers who have expressed interest in those goods and if any negative feedback is coming from other shoppers. The users that marked the any live sub deal of this deal as favorite are informed that this deal has been unexpectedly stopped by user feedback

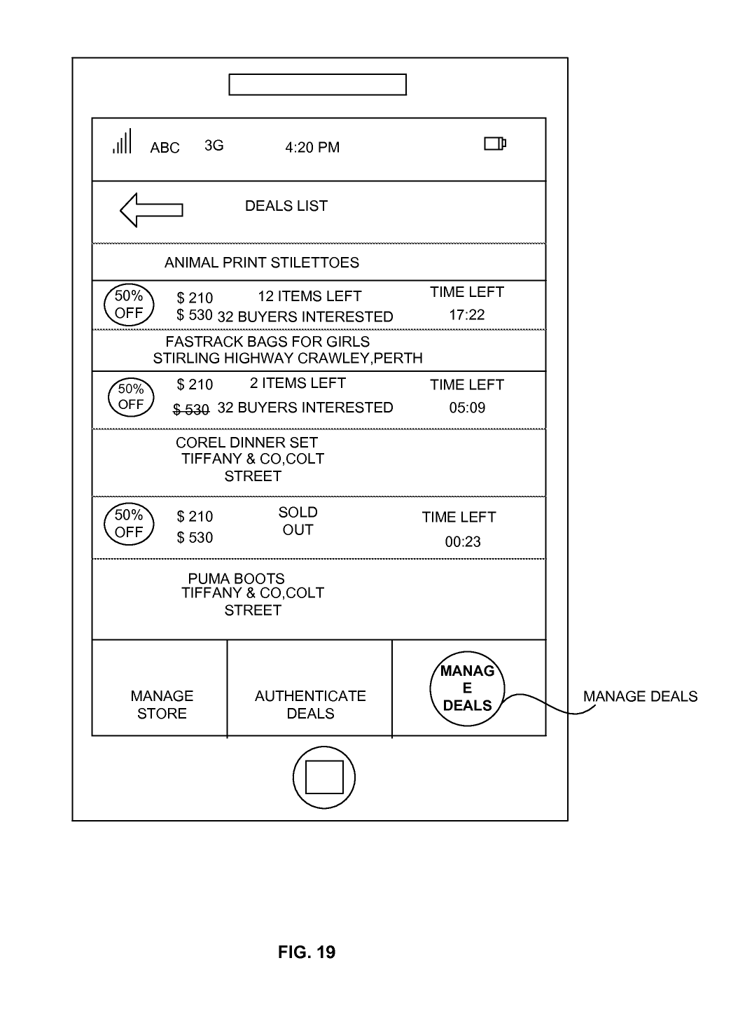

FIG. 19 illustrates a user interface view of a geospatial device running an application 108 of FIG. 1 according to an embodiment herein. In one embodiment, each merchant is able to set deals by accessing the “Manage Deals” icon that is displayed at the bottom right hand of FIG. 19. Under this menu merchant 102 of FIG. 1 can view all his deals and can stop, pause and play them as explained above.

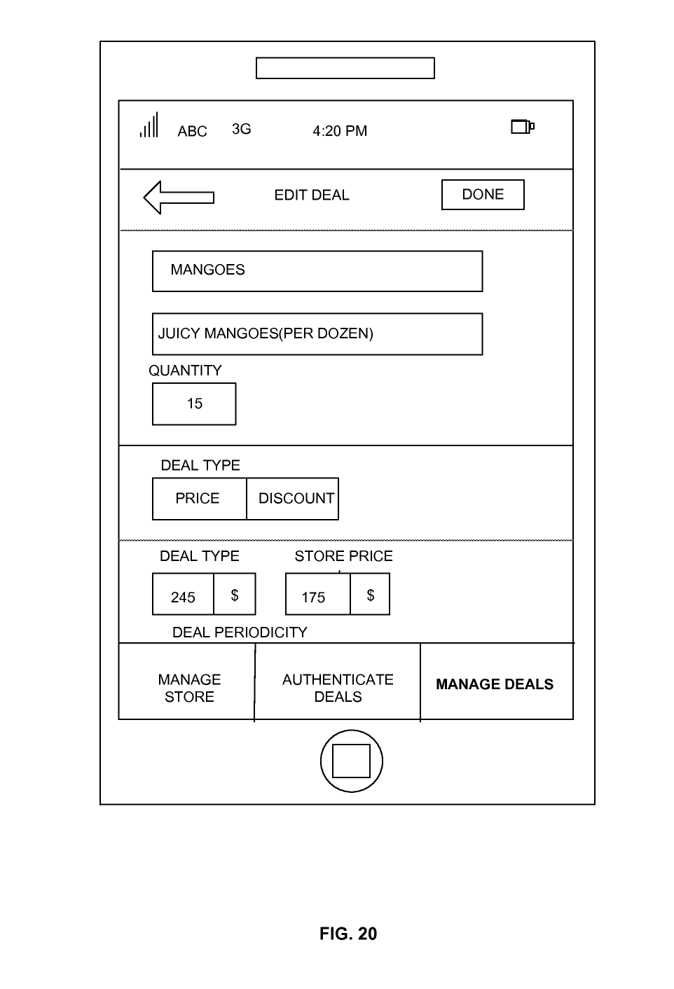

FIG. 20 illustrates a user interface view of a geospatial device running an application 108 of FIG. 1 according to an embodiment herein. In one embodiment, the merchant 102 of FIG. 1 is able to edit each selected deal. For example, data entry fields are provided for the merchant 102 of FIG. 1 to enter a description of the deal that he wishes to offer. The number of deals for the same product(s) that the merchant 102 of FIG. 1 wishes to make available can also be entered. For example, the merchant 102 of FIG. 1 may decide to provide ten offerings each of 4 kgs of apples for sale. The merchant 102 of FIG. 1 can then select to offer the deal as either a fixed dollar amount or as a discounted percentage off the normal price, e.g. “15% off”. Data entry fields are also provided for the merchant 102 of FIG. 1 to enter the price that a normal non-application shopper would pay and the price that a shopper 104 of FIG. 1 taking advantage of the offered deal via the mobile device application would pay.

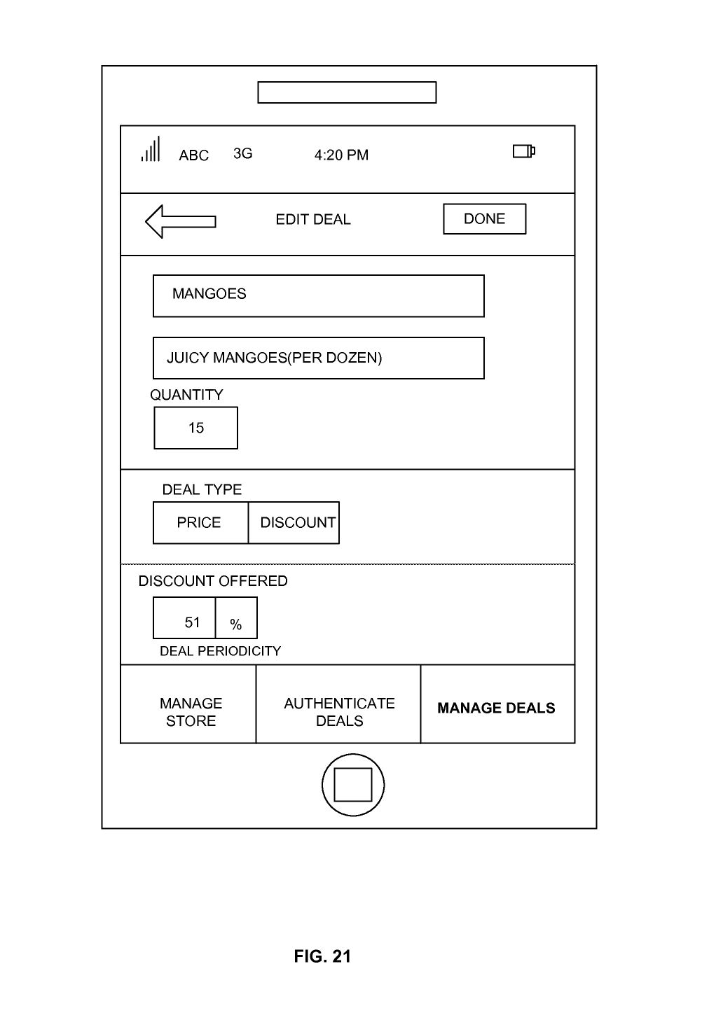

FIG. 21 illustrates a user interface view of a geospatial device running an application 108 of FIG. 1 according to an embodiment herein. In one embodiment, the merchant 102 of FIG. 1 then selects the “Deal Periodicity” link to be selected.

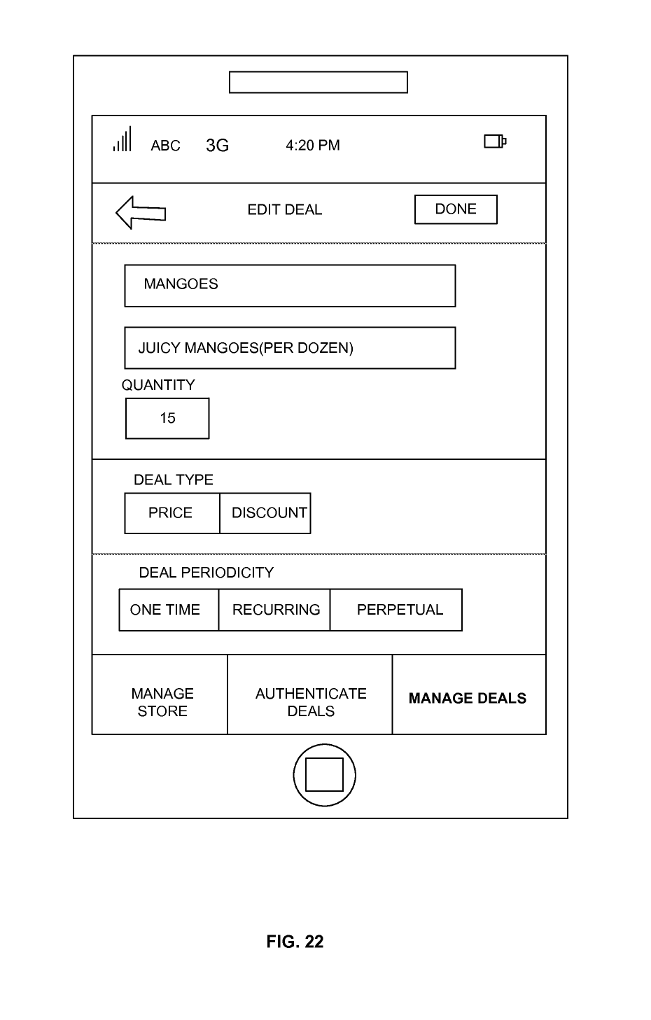

FIG. 22 illustrates a user interface view of a geospatial device running an application 108 of FIG. 1 according to an embodiment herein. In one embodiment, the merchant 102 of FIG. 1 is presented with options for selecting a onetime deal, a recurring deal or a perpetual deal (i.e. one with no end time.)

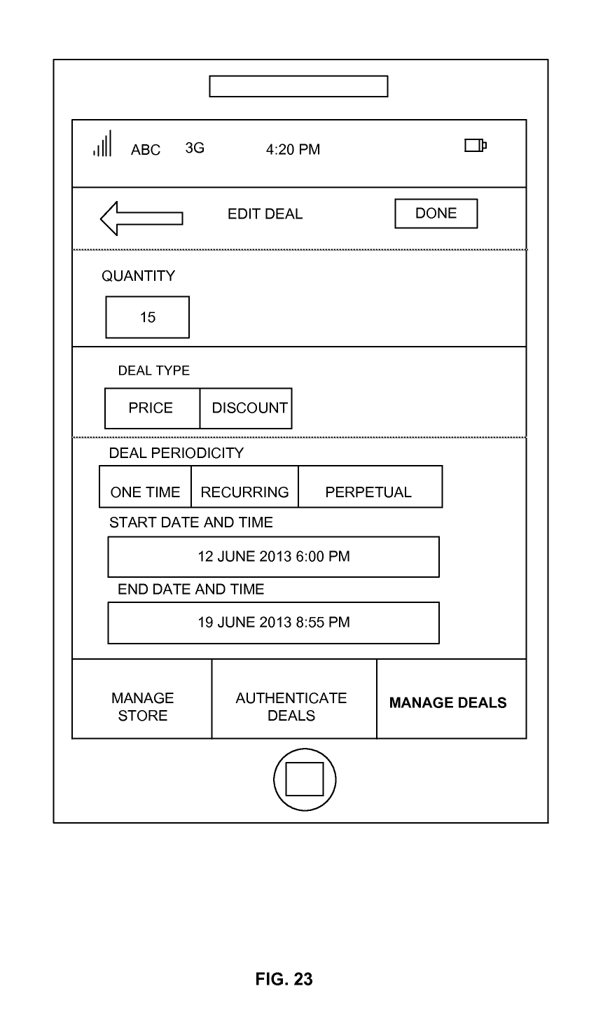

FIG. 23 illustrates a user interface view of a geospatial device running an application 108 of FIG. 1 according to an embodiment herein. In one embodiment, the merchant 102 of FIG. 1 is provided with fields for entering start and end date and time information for the deal. The start time and end time are outer limits within which the deal can be displayed to shoppers. The merchant is agnostic of his trading hours while presenting this information. For example, merchant may present a whole year as the deal duration. The store trading hours may be such that it is closed for Sundays and may have different trading hours according to seasons, day of week, and days of month and the deal will display in accordance with store's opening and closing.

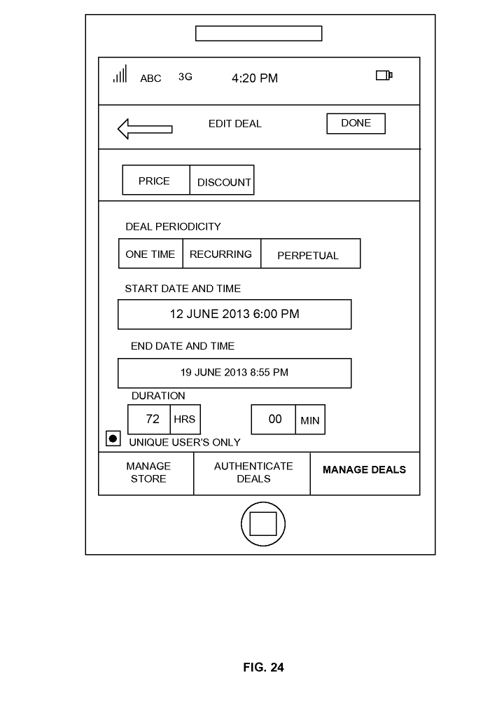

FIG. 24 illustrates a user interface view of a geospatial device running an application 108 of FIG. 1 according to an embodiment herein. In one embodiment, the merchant 102 of FIG. 1 is presented with fields for entering a start date and time and also for defining segment periods for the deal (e.g. 45 minutes). The start time and end time consist of long continuous periods, for example, it may be, that start time is midnight of first day of a year, and end time be midnight of last day of the year. The start time and end time capture the times when the deal may be shown to shoppers depending on the store's trading hours. However the merchant is not to be concerned with its business hours when presenting deals to the embodiment nor with any unforeseeable changes in trading hours.

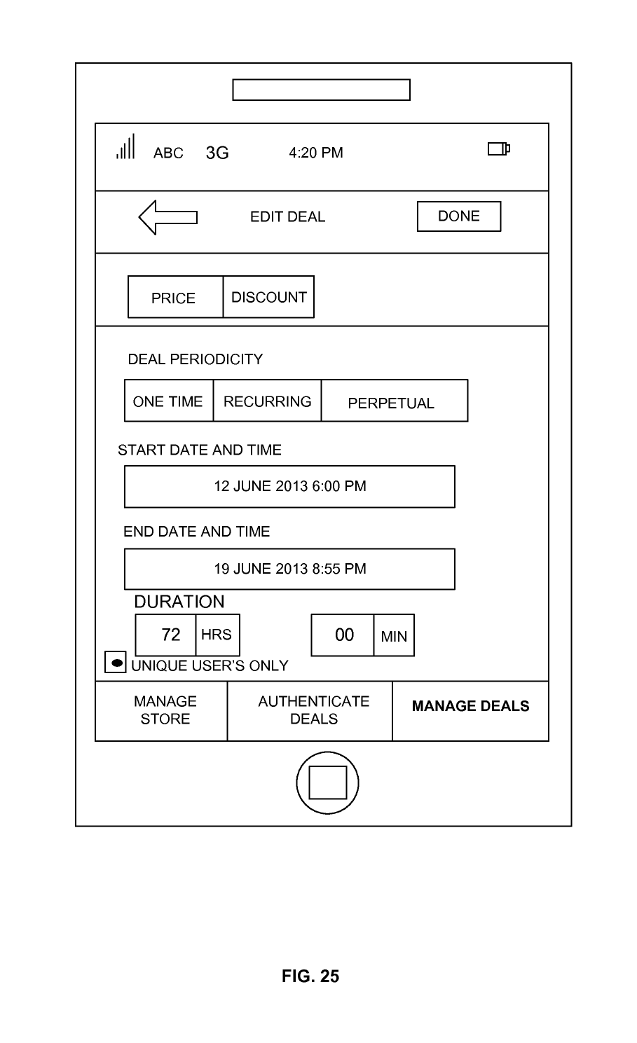

FIG. 25 illustrates a user interface view of a geospatial device running an application 108 of FIG. 1 according to an embodiment herein. In one embodiment, the merchant 102 of FIG. 1 is presented with fields for entering start date and time without an “end time” field. Unique users only ensure that same sub deal of same deal is not display to the user who has already availed.

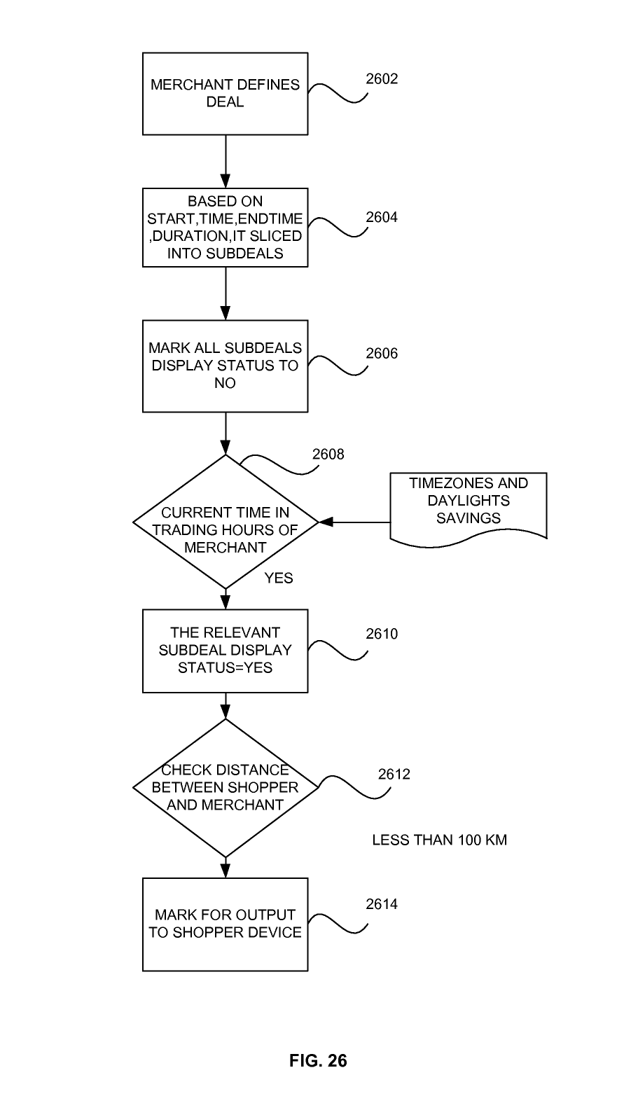

FIG. 26 is a flowchart of a method for deriving sub deals from a deal according to an embodiment herein. In step 2602, the merchant 102 of FIG. 1 defines a deal by entering deal details into his mobile device using the screens presented in FIGS. 19 to 24. The deal details are transmitted to the server 106 of FIG. 1 by the telecommunications network and internet. In step 2604, the server 106 of FIG. 1 slices the deal into sub deals based on the start time, end time and duration that the merchant 102 of FIG. 1 has entered the deal. In step 2606, the display status associated with each deal is initialized to “NO”, i.e. “do not display”. In step 2608, a check is performed to see if the merchant 102 of FIG. 1 offering the deal is currently open for trading. If he is open for trading then in step 2610 the relevant sub deal display status is set to “Yes”. In step 2612, the server 106 of FIG. 1 checks the distance between the shopper 104 of FIG. 1 and the merchant 102 of FIG. 1. If the distance is less than some predetermined value, e.g. 100 km, then in step 2614 the sub deal is marked for output to the remote device, i.e. the shopper device. The shopper's mobile device periodically communicates with the server 106 of FIG. 1 to determine if suitable sub deals, i.e. sufficiently close and for a merchant 102 of FIG. 1 that is open for trading, are available.

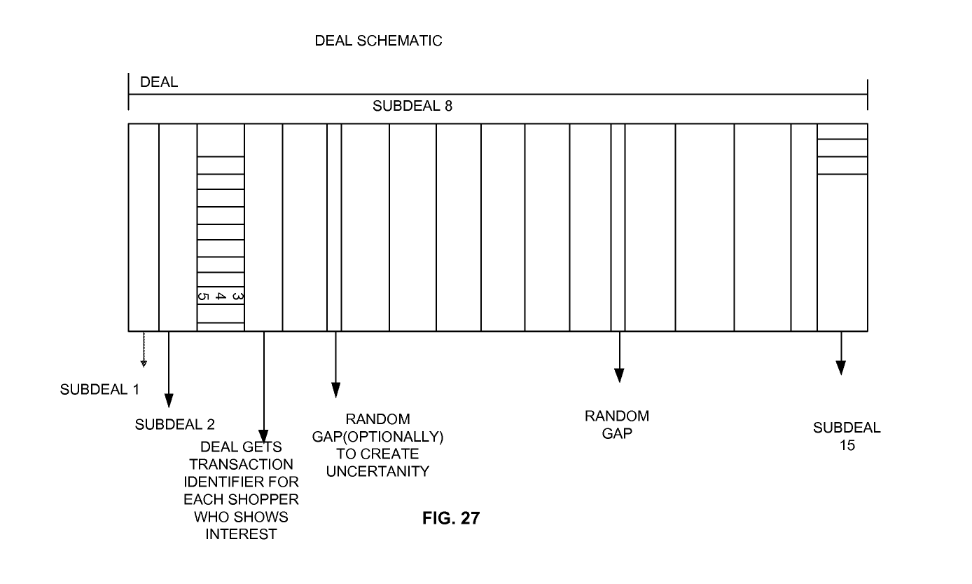

FIG. 27 is illustrates the division of a deal into a plurality of sub deals according to an embodiment herein. In one embodiment, deals are color coded red, yellow and green depending on the estimated travel time of the merchant's store from the shopper 104 of FIG. 1 to indicate probability of a deal's expiry before shopper's arrival at the store. This is done in the application 108 of FIG. 1. A method is implemented in the database 202 of FIG. 2 to code status of store opening and closing of a store with character literal strings of ‘red’, ‘yellow’, ‘green’, which is in no way related to visible color coding happening in application 108 of FIG. 1 as the visible color relates to the chance of successfully availing the deal due to travel time.

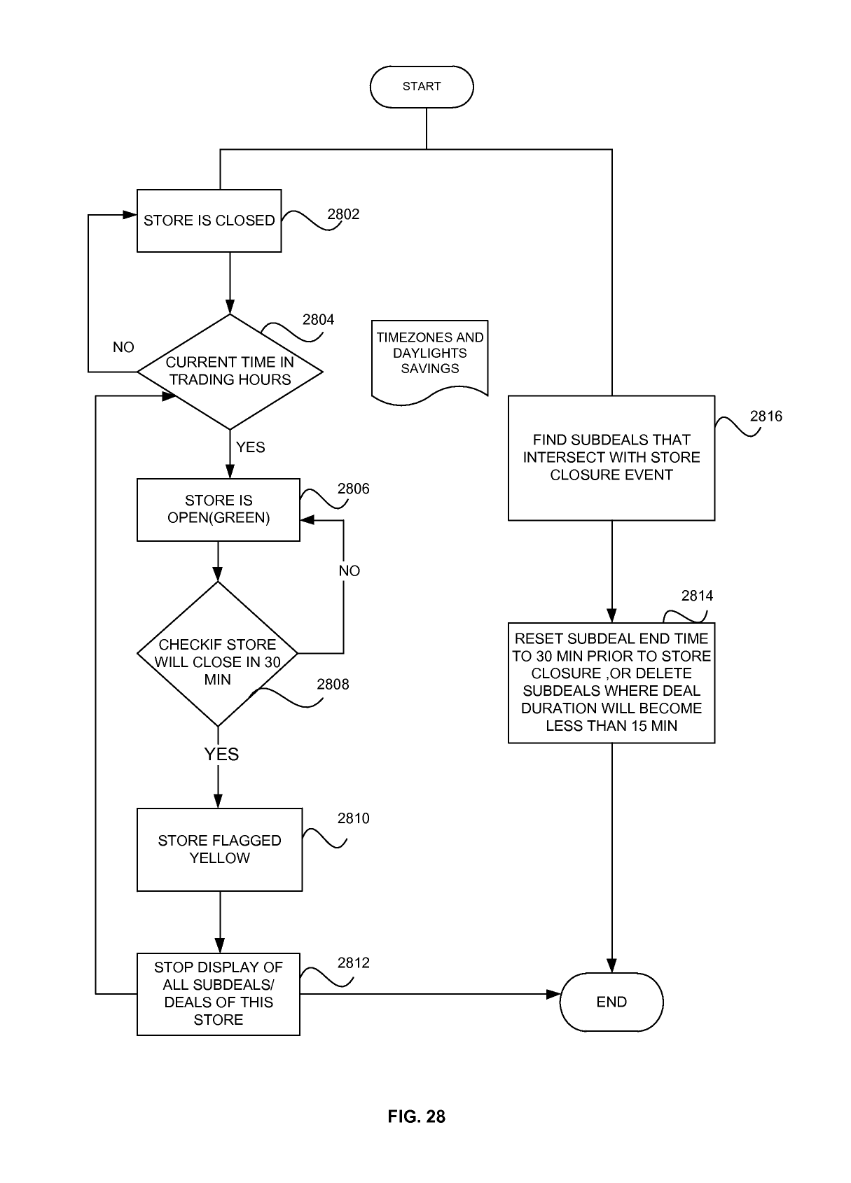

FIG. 28 is a flowchart of a method for processing merchant store closure according to an embodiment herein. In step 2802, the sub deals are initialized to their store opening status being “closed”. In step 2804, a check is performed to determine if the current time is within the merchant's store opening time. If it is within the store opening time then in step 2806 store opening status value is set to “Open” and the display code is set to ‘green’. In step 2808 a check is performed to determine if the store closing time is more than thirty minutes (or some other predetermined time) away. If it is then the process loops back to step 2806 and the store opening status remains as “Open” and the database code for the store remains “green”. If the store closing time is fifteen minutes or less away (or some other predetermined time) in step 2808 then in step 2810 the database code is set to ‘yellow’. And, as stated above, if the store is closed, its database code is red. Consequently, all deals of stores that have database code of yellow or red are set to stop display in step 2812. Hence, the deals are stopped in step 2812 when the store is about to close in say 15 30 minutes as merchants generally are busy shutting down premises, and may not be in a situation to honor deals, at the very last minute, as the shopper 104 of FIG. 1 also may have to travel which takes time.

A complimentary process for flagging sub deals that are being offered close to store closure and resetting their associated end times is implemented by steps 2814 and 2816. In step 2814 the system searches for sub deals that have timeframes that intersect with store closure events for their stores. In step 2816, the deal end time for the intersecting deals is reset to 30 minutes prior to store closure. As favorite deals linger for 15 minutes longer, so effectively all deals end 15 minutes prior to store closure. These two processes work in tandem to stop display of deals close to store closure times. The first process starts and stops the sub deal's display to shoppers in synchronization with store open/close status, whereas the second process truncates intersecting sub deal's end time such that corrected end time of sub deal gets communicated to the shopper device. They ensure the sub deal is displayed only during trading hours within the start and end time of the deal.

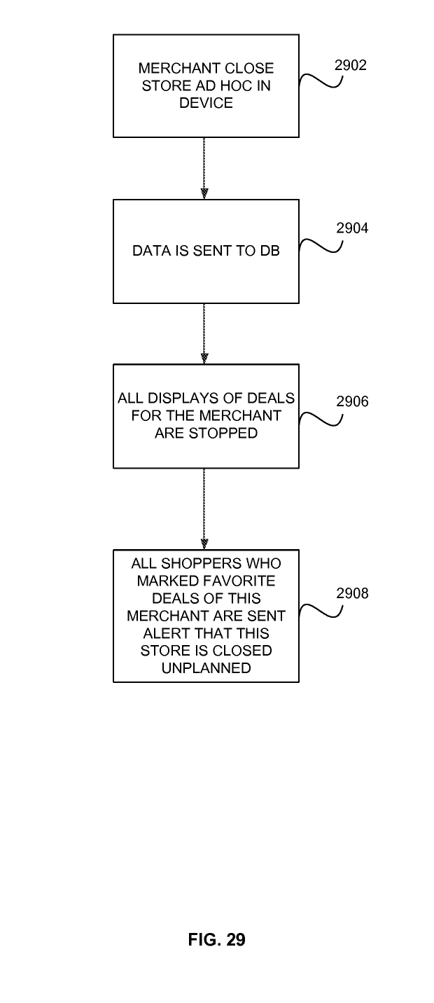

FIG. 29 is a flowchart of a method for processing ad hoc merchant store closure according to an embodiment herein. In step 2902, the merchant 102 of FIG. 1 closes the store ad hoc in his mobile device. In step 2904, the data is sent to the database. In step 2906, all displays of deals for the merchant 102 of FIG. 1 are stopped by the database. In step 2908, all shoppers who marked favorite deals of the merchant 102 of FIG. 1 are sent alert that this store is closed unexpectedly.

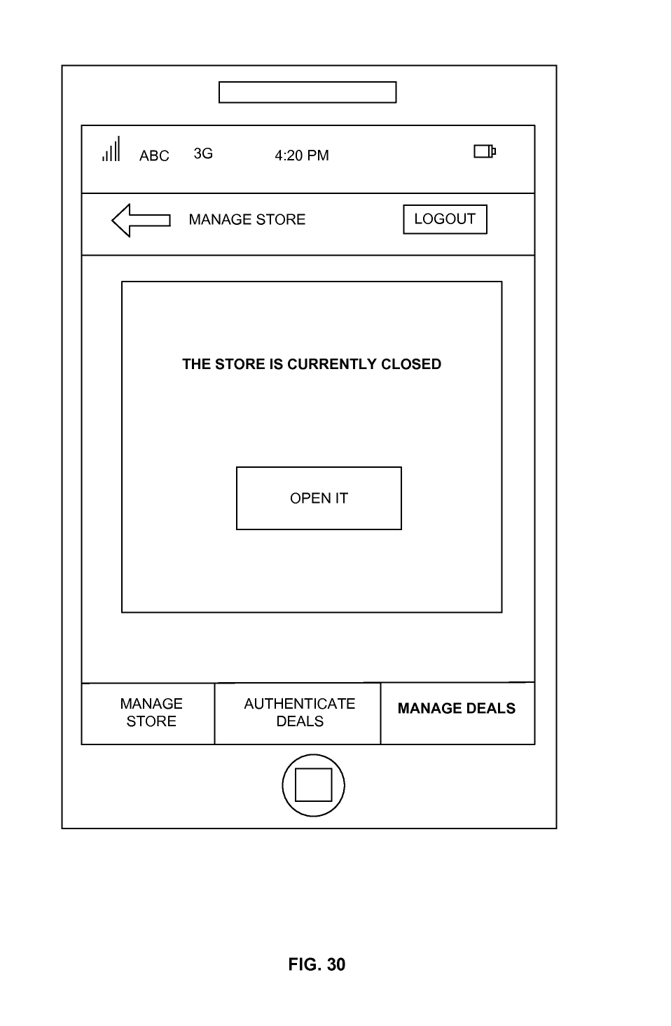

FIG. 30 illustrates a user interface view of a geospatial device running an application according to an embodiment herein. In one embodiment, it may be that a merchant 102 of FIG. 1 will need to close his store unexpectedly and not in conformance with its normal opening hours. Consequently, the system is arranged so that the store operator can emergency close his or her store any time and all the associated deals are promptly stopped.

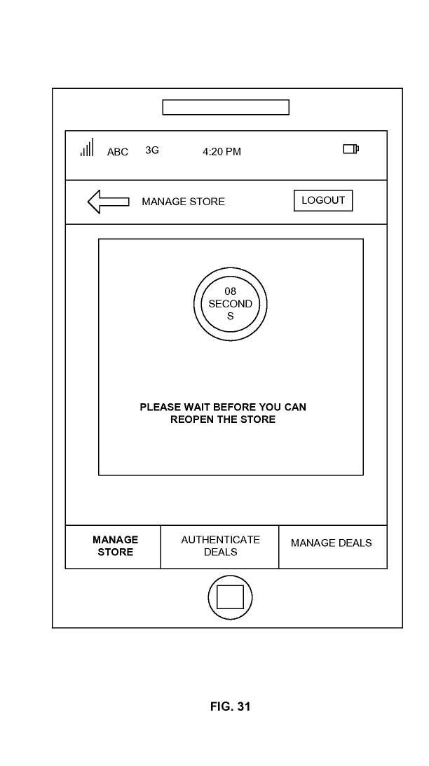

FIG. 31 illustrates a user interface view of a geospatial device running an application according to an embodiment herein. In one embodiment, for shoppers who marked favorite deals of that store are send an alert on those deals. If that happens, the store operator must open the store from the application in order for the normal functioning of the system to resume.

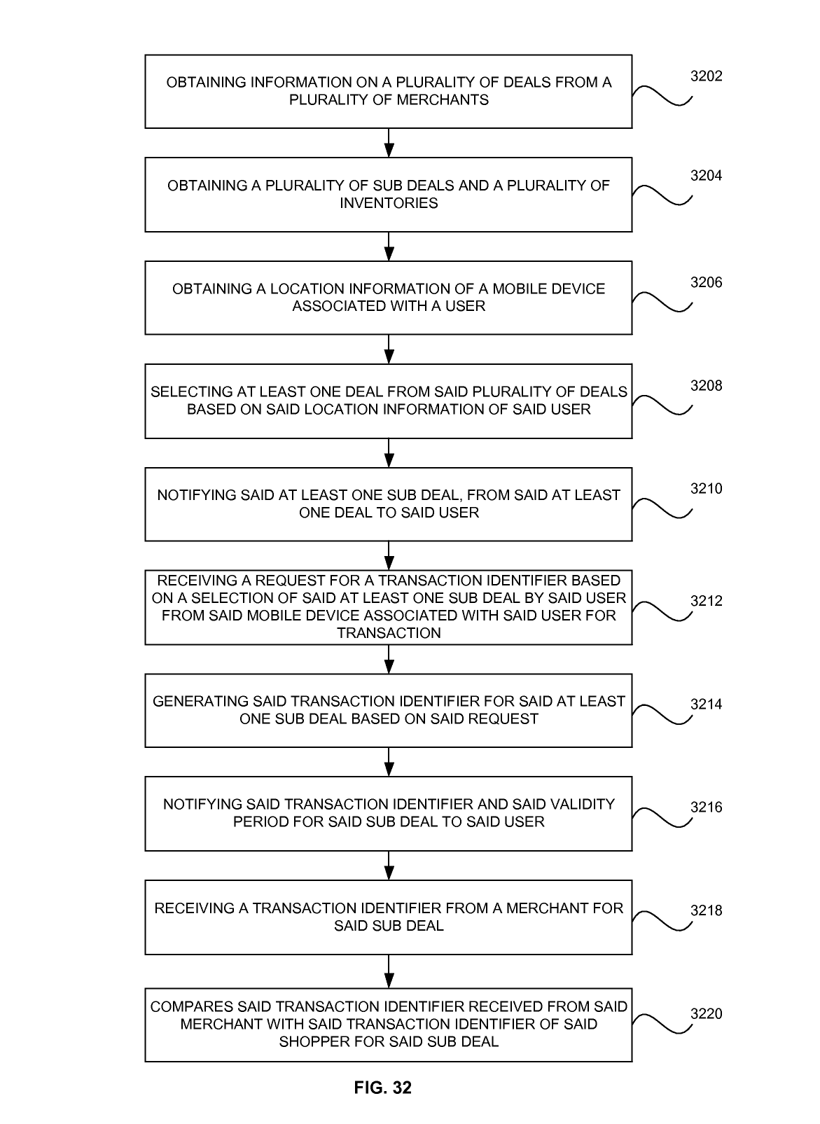

FIG. 32 is a flowchart of a method for splitting a deal into a sub deal according to an embodiment herein. In step 3202, information on one or more deals from one or more merchants is obtained. In step 3204, one or more sub deals and one or more inventories is obtained. In step 3206, location information of a mobile device associated with the shopper 104 of FIG. 1 is obtained. In step 3208, at least one deal from one or more deals is selected based on the location information of the shopper 104 of FIG. 1. In step 3210, at least one sub deal is notified from at least one deal to the shopper 104 of FIG. 1. In step 3212, request for a transaction identifier is received based on a selection of at least one sub deal by the shopper 104 of FIG. 1 from the mobile device associated with the shopper 104 of FIG. 1 for transaction.

In step 3214, the transaction identifier is generated for at least one sub deal based on the request. In step 3216, the transaction identifier and the validity period is notified for the sub deal to the shopper 104 of FIG. 1. In step 3218, a transaction identifier is received from the merchant 102 of FIG. 1 for the sub deal. In step 3220, the transaction identifier received from the merchant 102 of FIG. 1 is compared with the transaction identifier of the shopper 104 of FIG. 1 for the sub deal.

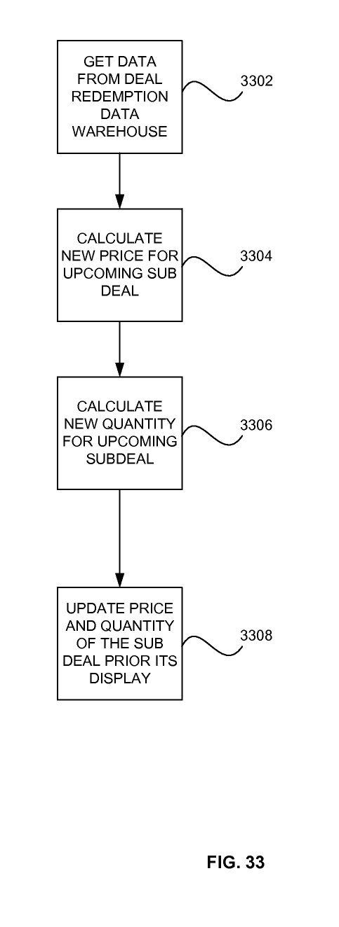

FIG. 33 is a flowchart of a method for updating price of a sub deals according to an embodiment herein. The system may include an inventory and deal updating module that updates an inventory, a price, and a number of remaining sub deals based on a utilization of previous sub deals. In step 3302, data from deal redemption data warehouse is received. In step 3304, new price for upcoming sub deal is calculated. In step 3306, new quantity for upcoming sub deal is calculated. New deal duration is also calculated for the upcoming deal, if required. In step 3308, price, quantity and duration of the sub deal is updated prior its display is updated.

The deal is split in which initially the price, inventory and duration of all sub deals is the same. However, as reaction on the initial sub deals from users reaches the server, the server can then re-calculate and assign new price, quantity or duration of the remaining sub deals. From the merchant, the nature of deal information may be obtained. The deals may fall in two categories: a) Foot fall: the goods for are in enough supply and they are not about to perish, the merchant wants to leverage them maximize traffic to his store, and b) sell fast: the goods are of perishable nature, e.g. dairy, and if not sold, the merchant will lose entire value. In this case, the total quantity is generally fixed. Based on the average number of units sold in corresponding set of previous sub deals periods, a new value of inventory is calculated.

However, if full inventory of a sub deal is sold, the rate at which the quantity is sold is determined and a projected value is determined that this sub deal could have sold, “sub_deal_capacity”. For example, if full quantity was sold within midway run of the deal, it is presumed that the potential to sell inventory for the same period (e.g. same time next week) can be double of what is exploited now. The server 106 of FIG. 1, then calculates true value of sub_deal_capacity and assigns it to the next period. The server 106 of FIG. 1, keeps iterating and keeps re calculating “sub_deal_capacity” of a deal the and retains historical data, to optimize the sale of inventory. In the event the inventory assigned to a sub deal is not sold entirely, we already know sub_deal_capacity” of that period, and the server 106 of FIG. 1, upon pre-agreement of merchant 102 of FIG. 1, may decrease price of the product automatically by a few percent and also decrease the inventory for the period to its previous corresponding period actual capacity. The objective is to sell maximum possible inventory within a sub deal at the maximum sellable price. Since these cannot be completely determined, the server, keeps calculating the same by giving 20% weightage to historical data older than 20% life of deal, and 80% to data from recent 20% life of deal in order to to determine appropriate quantity and price for the current period sub deal.

The quantity is fixed but if unsold, the goods may go waste. However, the fixed quantity can be optimally continuously re-distributed within the series of sub deals with fluctuating price in order to derive the maximum value for the merchant 102 of FIG. 1. Therefore, the server will use the same method as described above to determine how much quantity can be sold within a sub deal by determining sub_deal_capacity based on historical and recent data, and merchant's price and quantity considerations. However, if the merchant chooses, he may signal the server to over-project the inventory. For example, his actually inventory is 100, but he may over-project it by 500%. So if there are 10 sub deals, in each sub deal, there are 50 items on sale.

In each sub deal, the merchant 102 of FIG. 1 is not selling more than 100—which is his total inventory, hence within any sub deal he will not be misleading a customer, who actually may want to buy all the quality of the sub deal. As soon a sub deal is over, the server can re-calculate available quantity. At the same time, this maximizes his chance of selling the goods fast, because he can potentially sell, half of total in first sub deal itself. The server will start with a higher price. If the selling rate is looking promising, say 20% inventory is sold in the first sub deal itself, it will maintain that price. Otherwise, it will bring it down by a pre-agreed price percentage. If the product is still not selling much, the server may bring the project factor down from 500% to 400%—which will show that now the available quantity for a sub deal is 40 or less whereas as before it was 50. Therefore, anyone waiting for last minute bargain in the form of a distress sale will never be able to tell if the quantity on sale came down due to actual sale or a server trick. Hence, anyone seriously interested in the product should feel compelled to buy goods as they will be under the impression that it is selling like hot cakes, and they may miss out. In the scenario, the goods are actually selling like hot cakes, even then the server will undertake the same action, i.e. bring down the project factor, hence there will be no difference from which a shopper can tell what is the true picture and has to shop if the price is attractive enough for him At the same time, it is beneficial to the seller as merchant can sell most of his goods in short time if priced genuinely attractive as the sub deal will expire soon shopper does not know if it will renew or not. If a deal is not getting any sales, it may be assumed that the customers are perhaps not in proximity and they are far getting advised that the sub deal will expire before they will reach. The following sub deal duration will be increased. Whereas, if sub deal are getting oversubscribed quickly, the following sub deal duration will be reduced when inventory cannot be increased. This impacts number remaining sub deals while making the remaining sub deals better effective than previous ones.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims

What is claimed is:

1. A computer implemented system for generating and managing geographical specific deals, said system comprising:
(i) a memory unit that stores a database, and a set of modules;
(ii) a processor that executes said set of modules comprising;
(a) a deal information module, executed by said processor, that obtains information on deals from a plurality of merchants, wherein each deal comprises at least one product to be sold within a pre defined time interval;
(b) an inventory and deal splitting module, executed by said processor, that splits
(i) each inventory comprising said plurality of products to be sold into a plurality of deals; and
(ii) each deal comprising said plurality of products to be sold into a plurality of sub deals that are made available at different sub intervals of said pre defined time interval;
(c) a location module, executed by said processor, that obtains a location information of a mobile device associated with a shopper;
(d) a sub deal selection and notification module, executed by said processor, that
(i) selects at least one sub deal from a deal based on said location information of said shopper, wherein said deal and said sub deal are obtained from said database, and
(ii) notifies said at least one sub deal to said shopper, and
(e) a transaction identifier generation module, executed by said processor, that
(i) receives a request for a transaction identifier based on a selection of said at least one sub deal by said shopper from said mobile device associated with said shopper for transaction,
(ii) generates said transaction identifier for said at least one sub deal based on said request, and
(iii) notifies said transaction identifier to said shopper with a validity period for said transaction identifier.

2. The computer implemented system of claim 1, wherein transaction identifier comprises three to five symbols such as numbers, letters or a mixture of both.

3. The computer implemented system of claim 1, wherein location obtaining module obtains location of a store, and a location of other shoppers interested in said deal.

4. The computer implemented system of claim 1, wherein transaction identifier generation module reuses said transaction identifier for a new transaction after expiry of said deal associated with said transaction identifier.

5. The computer implemented system of claim 1, wherein a transaction identifier verification module that;
(a) compares (i) a transaction identifier received from a merchant with (ii) said transaction identifier of said shopper for said sub deal; and
(b) verifies whether said sub deal are being sold at a coupon price when a match is found between (i) said transaction identifier received from said merchant and (ii) said transaction identifier of said shopper.

6. The computer implemented system of claim 5, wherein said sub deal selection and notification module selects said at least one sub deal from said deal based on a trading hours of said merchant.

7. The computer implemented system of claim 1, further comprising an inventory and deal updating module that updates an inventory, a price, and a number of remaining sub deal based on a utilization of previous sub deals.

8. A computer implemented method for generating and managing geographical specific deals, said computer implemented method comprising:
(i) obtaining information on a plurality of deals from a plurality of merchants, wherein each deal comprises at least one product to be sold within a pre defined time interval,
(ii) obtaining
(a) a plurality of sub deals of said deal that are made available at different sub intervals of said pre defined time interval,
(iii) obtaining a location information of a mobile device associated with a shopper;
(iv) selecting at least one deal from said plurality of deals based on said location information of said shopper;
(v) notifying said at least one sub deal, from said at least one deal to said shopper, wherein said sub deal comprises a validity period after which said sub deal expires;
(vi) receiving a request for a transaction identifier based on a selection of said at least one sub deal by said shopper from said mobile device associated with said shopper for transaction;
(vii) generating said transaction identifier for said at least one sub deal based on said request;
(viii) notifying said transaction identifier and said validity period for said sub deal to said shopper;
(ix) receiving a transaction identifier from a merchant for said sub deal;
(x) compares said transaction identifier received from said merchant with said transaction identifier of said shopper for said sub deal.

9. The computer implemented method of claim 8, further comprising determining a geographical distance between a merchant's location and a current location of said shopper.

10. The computer implemented method of claim 8, further comprising notifying said shopper of said sub deal, wherein said sub deal comprises a price or discount, number of products remaining and time remaining to reach a merchant's location.

11. The computer implemented method of claim 8, further comprising said sub deals have an expiry time calculated such that shoppers that are already in the area of said merchant's location corresponding to said deal have adequate time to reach said merchant's location before the expiry time.

12. The computer implemented method of claim 8, further comprising processing a plurality of requests from a plurality of shopper devices received within at least one sub interval of said pre defined time interval, determining a number of interested shoppers in said at least one sub deal based on said plurality of requests for said at least one sub interval, and determining a plurality of products to be sold for said at least one sub deal within said at least one sub interval of said pre defined time interval.

13. The computer implemented method of claim 8, further comprising verifying whether said sub deal are being sold at a coupon price when a match is found between (i) said transaction identifier received from said merchant and (ii) said transaction identifier of said shopper.

14. A computer implemented device for availing for geographical specific deals comprising:
(i) a memory unit that stores a database, and a set of modules;
(ii) a processor that executes said set of modules comprising;
(a) a selection module, executed by said processor, that
(i) selects a first deal from a plurality of deals that is obtained from a server; and
(ii) receives a transaction identifier associated with said first deal;
(b) deal display module, executed by said processor, that
(i) displays, at an interface of said device, a price or discount information associated with said first deal, number of products in said first deal remaining to be sold, and duration remaining to avail said first deal; and
(ii) displays, at said interface, a second deal when a shopper rejects said first deal said shopper, and
(c) a categorizing module, executed by said processor, that categorizes said sub deal based on a color coding, wherein a particular color indicates that ample time is available, wherein another color indicates that there is barely enough time for a shopper to reach a shop that is associated with said sub deal.

15. The computer implemented device of claim 14, wherein said set of modules further comprises a feedback module that facilitates the submission of said shopper feedback

16. The computer implemented device of claim 14, wherein said set of modules further comprises an alert module that generates and displays an alert on said device prior to an expiry time of said deal.

17. The computer implemented device of claim 16, wherein said expiry time of said deal is updated based on a trading hours of a merchant associated with said deal.

18. A computer implemented device for utilizing geographical specific deals, said computer implemented method comprising device comprising:
(i) a memory unit that stores a database, and a set of modules;
(ii) a processor that executes said set of modules comprising;
(a) an inventory allocation module, executed by said processor, that allocates an inventory to shoppers from a plurality of inventories;
(b) a deal submission module, executed by said processor, that submits information specific to a deal to a server, wherein said information specific to said deal comprises an associated geographical location of a shop of a merchant and one or more associated time parameters indicating periods in which said deal is available;
(c) a fulfillment verification module, executed by said processor, that
(i) verifies an offer set out in said deal when a match is found between transaction identifier entered on said device with a transaction identifier that is stored in a server;
(ii) performs a check from said inventory, for (i) an availability of said deal and (ii) said offer set out in said deal; and
(iv) executes an action based on said check, and
(d) an operation module, executed by said processor, that terminates an operation on said deal when said deal is unavailable.

19. The computer implemented device of claim 18, wherein said action comprises completing a transaction associated with said deal, wherein said operation module further presents an option to said merchant to terminate said operation on said deal on completion of said transaction.

20. The computer implemented device of claim 18, wherein said action comprises declining a transaction associated with said deal, and wherein said operation module terminates said operation on said deal when said check from said inventory indicates that no further inventory is available.
